(19) United States
(12) Patent Application Publication
(10) Pub. No.: US 2026/0353378 A1
(43) Pub. Date: Nov. 5, 2026

(54) RESOURCE ALLOCATION AND COMMUNICATION TECHNIQUES FOR AMBIENT WIRELESS DEVICES

(71) Applicant: QUALCOMM Incorporated, San Diego, CA (US)

(72) Inventors: Luanxia YANG, Beijing (CN); Xiaojie WANG, Hillsborough, NJ (US); Xiaoxia ZHANG, San Diego, CA (US); Junyi LI, Fairless Hills, PA (US)

(21) Appl. No.: 19/153,855

(22) PCT Filed: Mar. 31, 2023
(86) PCT No.: PCT/CN2023/085352

§ 371 Date: Aug. 5, 2025

(51) Int. Cl. H04W 72/0453; H04W 72/04

(52) U.S. Cl. CPC H04W 72/0453; H04W 72/04

(57) ABSTRACT

Methods, systems, and devices for wireless communications are described. An ambient wireless device (e.g., a radio frequency identification (RFID) tag, an ambient internet-of-things (IoT) device, among other examples) may receive a control message that indicates a resource pool allocation for the ambient wireless device including a set of resources for backscatter communications between the ambient wireless device and a user equipment (UE). The ambient wireless device may communicate with the UE, via sidelink, using the set of resources. For example, the ambient wireless device may receive a continuous waveform from the UE or a second UE, modulate the continuous waveform with a sidelink message (e.g., a sidelink data message or feedback information), and send a backscattered signal of the modulate continuous waveform using a resource from the set of resources for backscatter communications.

### CROSS REFERENCE

The present Application for Patent is a 371 national phase filing of International Patent Application No. PCT/CN2023/085352 by YANG et al., entitled “RESOURCE ALLOCATION AND COMMUNICATION TECHNIQUES FOR AMBIENT WIRELESS DEVICES,” filed Mar. 31, 2023, assigned to the assignee hereof, and expressly incorporated by reference herein.

### INTRODUCTION

The following relates to wireless communications, including resource allocation and communication techniques between wireless devices.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communications at an ambient wireless device is described. The method may include receiving a control message that indicates a resource pool allocation for the ambient wireless device, the resource pool allocation including a set of multiple resources for backscatter communications between the ambient wireless device and a UE. In some examples, an ambient wireless device may receive, from the UE, a sidelink data message via a first resource of the set of multiple resources based on the resource pool allocation. The ambient wireless device may receive via a second resource of the set of multiple resources, a continuous waveform for activation of the ambient wireless device to provide feedback for the sidelink data message, modulate the continuous waveform with feedback information for the sidelink data message, and send, via a third resource of the set of multiple resources, a backscattered signal of the continuous waveform modulated with the feedback information for the sidelink data message.

An apparatus for wireless communications at an ambient wireless device is described. The apparatus may include a processor and memory coupled with the processor, the processor configured to receive a control message that indicates a resource pool allocation for the ambient wireless device, the resource pool allocation including a set of multiple resources for backscatter communications between the ambient wireless device and a UE. In some examples, the processor may be further configured to receive, from the UE, a sidelink data message via a first resource of the set of multiple resources based on the resource pool allocation. In some examples, the processor may be further configured to receive, via a second resource of the set of multiple resources, a continuous waveform for activation of the ambient wireless device to provide feedback for the sidelink data message, modulate the continuous waveform with feedback information for the sidelink data message, and send, via a third resource of the set of multiple resources, a backscattered signal of the continuous waveform modulated with the feedback information for the sidelink data message.

Another apparatus for wireless communications at an ambient wireless device is described. In some examples, the apparatus may include means for receiving a control message that indicates a resource pool allocation for the ambient wireless device, the resource pool allocation including a set of multiple resources for backscatter communications between the ambient wireless device and a UE. In some examples, the apparatus may further include means for receiving, from the UE, a sidelink data message via a first resource of the set of multiple resources based on the resource pool allocation, means for receiving, via a second resource of the set of multiple resources, a continuous waveform for activation of the ambient wireless device to provide feedback for the sidelink data message. In some examples, the apparatus may further include means for modulating the continuous waveform with feedback information for the sidelink data message, and for sending, via a third resource of the set of multiple resources, a backscattered signal of the continuous waveform modulated with the feedback information for the sidelink data message.

A non-transitory computer-readable medium storing code for wireless communications at an ambient wireless device is described. The code may include instructions executable by a processor to receive a control message that indicates a resource pool allocation for the ambient wireless device, the resource pool allocation including a set of multiple resources for backscatter communications between the ambient wireless device and a UE. In some examples, the code may further include instructions executable by the processor to receive, from the UE, a sidelink data message via a first resource of the set of multiple resources based on the resource pool allocation. In some examples, the code may further include instructions executable by the processor to receive, via a second resource of the set of multiple resources, a continuous waveform for activation of the ambient wireless device to provide feedback for the sidelink data message, modulate the continuous waveform with feedback information for the sidelink data message, and send, via a third resource of the set of multiple resources, a backscattered signal of the continuous waveform modulated with the feedback information for the sidelink data message.

In some examples of the method, apparatuses, and non-transitory computer-readable medium described herein, the continuous waveform may be received from the UE and the method, apparatuses, and non-transitory computer-readable medium may include further operations, features, means, or instructions for receiving, from the UE, a feedback resource message indicating that the third resource may be allocated for the ambient wireless device to provide feedback for the sidelink data message, the backscattered signal sent via the third resource based on the feedback resource message.

In some examples of the method, apparatuses, and non-transitory computer-readable medium described herein, sending the backscattered signal may include operations, features, means, or instructions for sending, via the third resource of the set of multiple resources, the backscattered signal, the third resource selected by the UE.

Some examples of the method, apparatuses, and non-transitory computer-readable medium described herein may further include operations, features, means, or instructions for receiving an indication of a set of resources for feedback for the sidelink data message based on a mapping of the first resource to the set of resources, the third resource selected from the set of resources.

Some examples of the method, apparatuses, and non-transitory computer-readable medium described herein may further include operations, features, means, or instructions for receiving, via the control message, an indication of a frequency range for the set of multiple resources for backscatter communications.

Some examples of the method, apparatuses, and non-transitory computer-readable medium described herein may further include operations, features, means, or instructions for receiving, via the control message, an indication of a guard band between the set of multiple resources for backscatter communications and a second set of multiple resources for sidelink communications.

Some examples of the method, apparatuses, and non-transitory computer-readable medium described herein may further include operations, features, means, or instructions for receiving a second continuous waveform for a discovery procedure between the ambient wireless device and the UE, modulating the second continuous waveform with an acknowledgment of the discovery procedure, and sending, as part of the discovery procedure, a second backscattered signal of the second continuous waveform modulated with the acknowledgment of the discovery procedure.

A method for wireless communications at a UE is described. The method may include receiving a control message that indicates a resource pool allocation for the UE, the resource pool allocation including a set of multiple resources for backscatter communications between the UE and an ambient wireless device. In some examples, the method may further include transmitting, to the ambient wireless device, a sidelink data message via a first resource of the set of multiple resources based on the resource pool allocation, transmitting, via a second resource of the set of multiple resources, a continuous waveform for activation of the ambient wireless device to provide feedback for the sidelink data message. In some examples, the method may further include receiving, via a third resource of the set of multiple resources, a backscattered signal of the continuous waveform modulated with feedback information for the sidelink data message.

An apparatus for wireless communications at a UE is described. The apparatus may include a processor and memory coupled with the processor, the processor configured to receive a control message that indicates a resource pool allocation for the UE, the resource pool allocation including a set of multiple resources for backscatter communications between the UE and an ambient wireless device. In some examples, the processor and memory may be further configured to transmit, to the ambient wireless device, a sidelink data message via a first resource of the set of multiple resources based on the resource pool allocation, transmit, via a second resource of the set of multiple resources, a continuous waveform for activation of the ambient wireless device to provide feedback for the sidelink data message. In some examples, the processor and memory may be further configured to receive, via a third resource of the set of multiple resources, a backscattered signal of the continuous waveform modulated with feedback information for the sidelink data message.

Another apparatus for wireless communications at a UE is described. The apparatus may include means for receiving a control message that indicates a resource pool allocation for the UE, the resource pool allocation including a set of multiple resources for backscatter communications between the UE and an ambient wireless device. In some examples, the apparatus may further include means for transmitting, to the ambient wireless device, a sidelink data message via a first resource of the set of multiple resources based on the resource pool allocation. In some examples, the apparatus may further include means for transmitting, via a second resource of the set of multiple resources, a continuous waveform for activation of the ambient wireless device to provide feedback for the sidelink data message. In some examples, the apparatus may further include means for receiving, via a third resource of the set of multiple resources, a backscattered signal of the continuous waveform modulated with feedback information for the sidelink data message.

A non-transitory computer-readable medium storing code for wireless communications at a UE is described. The code may include instructions executable by a processor to receive a control message that indicates a resource pool allocation for the UE, the resource pool allocation including a set of multiple resources for backscatter communications between the UE and an ambient wireless device. In some examples, the code may further include instructions executable by the processor to transmit, to the ambient wireless device, a sidelink data message via a first resource of the set of multiple resources based on the resource pool allocation. In some examples, the code may further include instructions executable by the processor to transmit, via a second resource of the set of multiple resources, a continuous waveform for activation of the ambient wireless device to provide feedback for the sidelink data message. In some examples, the code may further include instructions executable by the processor to receive, via a third resource of the set of multiple resources, a backscattered signal of the continuous waveform modulated with feedback information for the sidelink data message.

Some examples of the method, apparatuses, and non-transitory computer-readable medium described herein may further include operations, features, means, or instructions for transmitting, to the ambient wireless device, a feedback resource message indicating that the third resource may be allocated for feedback for the sidelink data message, the backscattered signal received via the third resource based on the feedback resource message.

Some examples of the method, apparatuses, and non-transitory computer-readable medium described herein may further include operations, features, means, or instructions for receiving, via the control message, an indication of a frequency range for the set of multiple resources for backscatter communications.

Some examples of the method, apparatuses, and non-transitory computer-readable medium described herein may further include operations, features, means, or instructions for receiving, via the control message, an indication of a guard band between the set of multiple resources for backscatter communications and a second set of multiple resources for sidelink communications.

Some examples of the method, apparatuses, and non-transitory computer-readable medium described herein may further include operations, features, means, or instructions for transmitting, to the ambient wireless device, a second continuous waveform for a discovery procedure between the ambient wireless device and the UE and receiving, from the ambient wireless device as part of the discovery procedure, a second backscattered signal of the second continuous waveform modulated with an acknowledgment of the discovery procedure.

A method for wireless communications at a second UE is described. The method may include receiving a control message that indicates a resource pool allocation for the second UE, the resource pool allocation including a set of multiple resources for backscatter communications for a first UE, the second UE, and an ambient wireless device. In some examples, the method may further include transmitting, via a first resource of the set of multiple resources to the ambient wireless device, a continuous waveform for activation of the ambient wireless device for the ambient wireless device to provide feedback to the first UE.

An apparatus for wireless communications at a second UE is described. The apparatus may include a processor and memory coupled with the processor, the processor configured to receive a control message that indicates a resource pool allocation for the second UE, the resource pool allocation including a set of multiple resources for backscatter communications for a first UE, the second UE, and an ambient wireless device. In some examples, the processor and memory may be further configured to transmit, via a first resource of the set of multiple resources to the ambient wireless device, a continuous waveform for activation of the ambient wireless device for the ambient wireless device to provide feedback to the first UE.

Another apparatus for wireless communications at a second UE is described. The apparatus may include means for receiving a control message that indicates a resource pool allocation for the second UE, the resource pool allocation including a set of multiple resources for backscatter communications for a first UE, the second UE, and an ambient wireless device. In some examples, the apparatus may further include means for transmitting, via a first resource of the set of multiple resources to the ambient wireless device, a continuous waveform for activation of the ambient wireless device for the ambient wireless device to provide feedback to the first UE.

A non-transitory computer-readable medium storing code for wireless communications at a second UE is described. The code may include instructions executable by a processor to receive a control message that indicates a resource pool allocation for the second UE, the resource pool allocation including a set of multiple resources for backscatter communications for a first UE, the second UE, and an ambient wireless device. In some examples, the code may further include instructions executable by the processor to transmit, via a first resource of the set of multiple resources to the ambient wireless device, a continuous waveform for activation of the ambient wireless device for the ambient wireless device to provide feedback to the first UE.

A method for wireless communications an ambient wireless device is described. The method may include receiving a control message that indicates a resource pool allocation for the ambient wireless device, the resource pool allocation including a set of multiple resources for backscatter communications between the ambient wireless device and a UE. In some examples, the method may further include receiving an indication of one or more resources of the set of multiple resources for the ambient wireless device to use to backscatter a sidelink data message. In some examples, the method may further include receiving, via a first resource of the one or more resources, a continuous waveform for sidelink communications from the ambient wireless device, modulating the continuous waveform with the sidelink data message, and sending, via a second resource of the one or more resources, a backscattered signal of the continuous waveform modulated with the sidelink data message.

An apparatus for wireless communications at an ambient wireless device is described. The apparatus may include a processor and memory coupled with the processor, the processor configured to receive a control message that indicates a resource pool allocation for the ambient wireless device, the resource pool allocation including a set of multiple resources for backscatter communications between the ambient wireless device and a UE. In some examples, the processor and memory may be further configured to receive an indication of one or more resources of the set of multiple resources for the ambient wireless device to use to backscatter a sidelink data message. In some examples, the processor and memory may be further configured to receive, via a first resource of the one or more resources, a continuous waveform for sidelink communications from the ambient wireless device, modulate the continuous waveform with the sidelink data message, and send, via a second resource of the one or more resources, a backscattered signal of the continuous waveform modulated with the sidelink data message.

Another apparatus for wireless communications at an ambient wireless device is described. The apparatus may include means for receiving a control message that indicates a resource pool allocation for the ambient wireless device, the resource pool allocation including a set of multiple resources for backscatter communications between the ambient wireless device and a UE. In some examples, the apparatus may further include means for receiving an indication of one or more resources of the set of multiple resources for the ambient wireless device to use to backscatter a sidelink data message. In some examples, the apparatus may further include means for receiving, via a first resource of the one or more resources, a continuous waveform for sidelink communications from the ambient wireless device, modulating the continuous waveform with the sidelink data message, and sending, via a second resource of the one or more resources, a backscattered signal of the continuous waveform modulated with the sidelink data message.

A non-transitory computer-readable medium storing code for wireless communications at an ambient wireless device is described. The code may include instructions executable by a processor to receive a control message that indicates a resource pool allocation for the ambient wireless device, the resource pool allocation including a set of multiple resources for backscatter communications between the ambient wireless device and a UE. In some examples, the code may further include instructions executable by the processor to receive an indication of one or more resources of the set of multiple resources for the ambient wireless device to use to backscatter a sidelink data message. In some examples, the code may further include instructions executable by the processor to receive, via a first resource of the one or more resources, a continuous waveform for sidelink communications from the ambient wireless device, modulate the continuous waveform with the sidelink data message, and send, via a second resource of the one or more resources, a backscattered signal of the continuous waveform modulated with the sidelink data message.

Some examples of the method, apparatuses, and non-transitory computer-readable medium described herein may further include operations, features, means, or instructions for receiving, from the UE, a feedback message that includes feedback information associated with the sidelink data message based on the backscattered signal of the continuous waveform modulated with the sidelink data message.

Some examples of the method, apparatuses, and non-transitory computer-readable medium described herein may further include operations, features, means, or instructions for receiving a second continuous waveform for activation of the ambient wireless device to perform backscatter communications, modulating the second continuous waveform with a backscatter request message associated with the sidelink data message, the backscatter request message including a request for one or more resources for the ambient wireless device to send the sidelink data message, and sending, via a third resource of the set of multiple resources, a second backscattered signal of the second continuous waveform modulated with the backscatter request message.

Some examples of the method, apparatuses, and non-transitory computer-readable medium described herein may further include operations, features, means, or instructions for receiving the second continuous waveform from the UE or a second UE different from the UE.

In some examples of the method, apparatuses, and non-transitory computer-readable medium described herein, the third resource of the set of multiple resources may be allocated for the ambient wireless device to send one or more backscatter request messages and the third resource may be common to a set of ambient wireless devices or may be a resource of a communication link associated with the ambient wireless device.

Some examples of the method, apparatuses, and non-transitory computer-readable medium described herein may further include operations, features, means, or instructions for sending an indication that the ambient wireless device selected the second resource of the one or more resources to backscatter the sidelink data message and receiving an acknowledgment message for the indication of the second resource.

In some examples of the method, apparatuses, and non-transitory computer-readable medium described herein, receiving the indication of the one or more resources may include operations, features, means, or instructions for receiving the indication of the one or more resources of the set of multiple resources from the UE or a second UE different from the UE.

Some examples of the method, apparatuses, and non-transitory computer-readable medium described herein may further include operations, features, means, or instructions for receiving a second continuous waveform for a discovery procedure between the ambient wireless device and the UE, modulating the second continuous waveform with capability information of the ambient wireless device, and sending, as part of the discovery procedure, a second backscattered signal of the second continuous waveform modulated with the capability information of the ambient wireless device.

In some examples of the method, apparatuses, and non-transitory computer-readable medium described herein, the capability information includes capability of frequency shifting at the ambient wireless device, whether the ambient wireless device includes a band pass filter, or both.

A method for wireless communications at a UE is described. The method may include receiving a control message that indicates a resource pool allocation for the UE, the resource pool allocation including a set of multiple resources for backscatter communications between the UE and an ambient wireless device. In some examples, the method may further include transmitting an indication of one or more resources of the set of multiple resources for the ambient wireless device to use to backscatter a sidelink data message. In some examples, the method may further include transmitting, via a first resource of the one or more resources, a continuous waveform for sidelink communications at the ambient wireless device. In some examples, the method may further include receiving, via a second resource of the one or more resources, a backscattered signal of the continuous waveform modulated with the sidelink data message.

An apparatus for wireless communications at a UE is described. The apparatus may include a processor and memory coupled with the processor, the processor configured to receive a control message that indicates a resource pool allocation for the UE, the resource pool allocation including a set of multiple resources for backscatter communications between the UE and an ambient wireless device. In some examples, the processor and memory may be further configured to transmit an indication of one or more resources of the set of multiple resources for the ambient wireless device to use to backscatter a sidelink data message. In some examples, the processor and memory may be further configured to transmit, via a first resource of the one or more resources, a continuous waveform for sidelink communications at the ambient wireless device. In some examples, the processor and memory may be further configured to receive, via a second resource of the one or more resources, a backscattered signal of the continuous waveform modulated with the sidelink data message.

Another apparatus for wireless communications is described. The apparatus may include means for receiving a control message that indicates a resource pool allocation for the UE, the resource pool allocation including a set of multiple resources for backscatter communications between the UE and an ambient wireless device. In some examples, the apparatus may further include means for transmitting an indication of one or more resources of the set of multiple resources for the ambient wireless device to use to backscatter a sidelink data message. In some examples, the apparatus may further include means for transmitting, via a first resource of the one or more resources, a continuous waveform for sidelink communications at the ambient wireless device. In some examples, the apparatus may further include means for receiving, via a second resource of the one or more resources, a backscattered signal of the continuous waveform modulated with the sidelink data message.

A non-transitory computer-readable medium storing code for wireless communications is described. The code may include instructions executable by a processor to receive a control message that indicates a resource pool allocation for the UE, the resource pool allocation including a set of multiple resources for backscatter communications between the UE and an ambient wireless device. In some examples, the code may further include instructions executable by the processor to transmit an indication of one or more resources of the set of multiple resources for the ambient wireless device to use to backscatter a sidelink data message. In some examples, the code may further include instructions executable by the processor to transmit, via a first resource of the one or more resources, a continuous waveform for sidelink communications at the ambient wireless device. In some examples, the code may further include instructions executable by the processor to receive, via a second resource of the one or more resources, a backscattered signal of the continuous waveform modulated with the sidelink data message.

Some examples of the method, apparatuses, and non-transitory computer-readable medium described herein may further include operations, features, means, or instructions for transmitting, to the ambient wireless device, a feedback message associated with the sidelink data message based on the received backscattered signal of the continuous waveform modulated with the sidelink data message.

Some examples of the method, apparatuses, and non-transitory computer-readable medium described herein may further include operations, features, means, or instructions for transmitting, to the ambient wireless device, a second continuous waveform for activation of the ambient wireless device to perform backscatter communications and receiving, via a third resource of the set of multiple resources, a second backscattered signal of the second continuous waveform modulated with a backscatter request message that requests an indication of one or more resources for the ambient wireless device to send the sidelink data message.

In some examples of the method, apparatuses, and non-transitory computer-readable medium described herein, the third resource of the set of multiple resources may be allocated for the ambient wireless device to send one or more backscatter request messages.

In some examples of the method, apparatuses, and non-transitory computer-readable medium described herein, transmitting the indication of one or more resources of the set of multiple resources may include operations, features, means, or instructions for transmitting the indication of one or more resources of the set of multiple resources, the one or more resources selected based on a capability of the ambient wireless device.

In some examples of the method, apparatuses, and non-transitory computer-readable medium described herein, a frequency of the second resource of the one or more resources may be greater than a bandwidth of a bandpass filter associated with the ambient wireless device.

Some examples of the method, apparatuses, and non-transitory computer-readable medium described herein may further include operations, features, means, or instructions for receiving an indication that the ambient wireless device selected the second resource of the one or more resources to backscatter the sidelink data message and transmitting an acknowledgment message that the ambient wireless device selected the second resource of the one or more resources to backscatter the sidelink data message.

Some examples of the method, apparatuses, and non-transitory computer-readable medium described herein may further include operations, features, means, or instructions for transmitting, to the ambient wireless device, a second continuous waveform for a discovery procedure between the ambient wireless device and the UE and receiving, from the ambient wireless device as part of the discovery procedure, a second backscattered signal of the second continuous waveform modulated with capability information of the ambient wireless device.

In some examples of the method, apparatuses, and non-transitory computer-readable medium described herein, the capability information includes capability of frequency shifting at the ambient wireless device, whether the ambient wireless device includes a band pass filter, or both.

Some examples of the method, apparatuses, and non-transitory computer-readable medium described herein may further include operations, features, means, or instructions for transmitting, to multiple ambient wireless devices, respective indications of resources for the multiple ambient wireless devices to use to backscatter respective sidelink data messages.

### BRIEF DESCRIPTION OF THE DRAWINGS

FIG. 1 shows an example of a wireless communications system that supports resource allocation and communication techniques for ambient wireless devices in accordance with one or more aspects of the present disclosure.

FIG. 2 shows an example of a network architecture that supports resource allocation and communication techniques for ambient wireless devices in accordance with one or more aspects of the present disclosure.

FIG. 3 shows an example of a wireless communications system that supports resource allocation and communication techniques for ambient wireless devices in accordance with one or more aspects of the present disclosure.

FIG. 4 through 6 show respective examples of a process flow that supports resource allocation and communication techniques for ambient wireless devices in accordance with one or more aspects of the present disclosure.

FIGS. 7 and 8 show block diagrams of devices that support resource allocation and communication techniques for ambient wireless devices in accordance with one or more aspects of the present disclosure.

FIG. 9 shows a block diagram of a communications manager that supports resource allocation and communication techniques for ambient wireless devices in accordance with one or more aspects of the present disclosure.

FIG. 10 shows a diagram of a system including a device that supports resource allocation and communication techniques for ambient wireless devices in accordance with one or more aspects of the present disclosure.

FIGS. 11 through 19 show flowcharts illustrating methods that support resource allocation and communication techniques for ambient wireless devices in accordance with one or more aspects of the present disclosure.

### DETAILED DESCRIPTION

In some examples of wireless communications, a wireless device, such as a UE may communicate with an ambient wireless device (e.g., a radio frequency identification (RFID) tag, an ambient internet-of-things (IoT) device, among other examples). For instance, the UE may transmit a continuous waveform to the ambient wireless device. A continuous waveform may be an electromagnetic wave of constant amplitude and frequency (e.g., a sine wave). In some examples, the ambient wireless device may use the continuous waveform to send a backscattered signal to the UE. A backscattered signal may be a reflection of the continuous waveform that the ambient wireless device sends back in the direction of the UE. In some examples, the ambient wireless device may include additional information (e.g., a set of data bits) in the backscattered signal. For example, the ambient wireless device may modulate the continuous waveform with the set of data bits and reflect the modulated continuous waveform back to the UE as a backscattered signal. In some examples of reflection, the ambient wireless device may receive the continuous waveform from the UE and change the direction of the continuous waveform using the reflector (e.g., reflect the continuous waveform toward a same or similar direction in which it was received). As such, ambient wireless devices may be configured to use continuous waveforms received from other wireless devices to activate, perform sensing, resource selection, and transmissions. In some cases, however, ambient wireless devices may not be configured to perform sensing, resource selection, and transmissions independent of other wireless devices (e.g., independent of receiving a continuous waveform). As such, exchanging various messages with an ambient wireless device via a communications link (e.g., sidelink) may be limited without a procedure to implement signaling to support continuous backscattered signaling from the ambient wireless device. Limitations associated with performing sidelink communications with the ambient wireless device may reduce the reliability of ambient wireless devices (e.g., when the quantity of sidelink messages increases in a system), which may lead to inefficient resource utilization and reduce the overall throughput and efficiency of the system.

A UE and an ambient wireless device may communicate via sidelink, according to the techniques described herein. For example, an associated network may transmit a control message to the UE and ambient wireless device, which indicates a resource pool allocation. In some examples, a resource pool allocation may allocate one or more resource pools to the UE and ambient wireless. A resource pool may include an aggregated collection of resources (e.g., time and frequency resources) that the UE and ambient wireless device may use to communicate via sidelink. For example, the resource pool allocation may indicate a set of one or more resources associated with backscattering communications (e.g., resources that the ambient wireless device may use to send a backscattered signal of a received continuous waveform).

In some examples, the UE may use the resources of the resource pool to transmit a sidelink data message to the ambient wireless device. Additionally, the UE may transmit an indication of a feedback resource from the resource pool allocation that the ambient wireless device may use to send feedback for the received sidelink data message. In some examples, the feedback may be a hybrid automatic repeat request (HARQ) acknowledgment (HARQ-ACK) that acknowledges receipt of the sidelink data message. As such, the UE or a second UE (e.g., an anchor UE) may transmit a continuous waveform that the ambient wireless device may use to backscatter the feedback. For example, the ambient wireless device may modulate the continuous waveform with feedback information (e.g., a set of bits pertaining to feedback for the sidelink data message). As such, the ambient wireless device may send a backscattered signal of the continuous waveform modulated with the feedback information.

In some examples, the anchor UE may transmit the continuous waveform on behalf of the UE based on a configuration of the UE. For example, the UE may be configured to operate in a full-duplex. A full-duplex mode operation may allow the UE to concurrently transmit the continuous waveform to the ambient wireless device and receive a backscattered signal of the continuous waveform. As such, if the UE is not operating in a full-duplex mode, the anchor UE may transmit the continuous waveform to the ambient wireless device so the UE may receive the backscattered signal of the continuous waveform.

In some examples, the ambient wireless device may send a sidelink data message to the UE. In some examples, the ambient wireless device may transmit a request to backscatter (RTB) to the UE and, the UE may transmit an indication of one or more candidate resources the ambient wireless device may use to backscatter the sidelink data message. In some other examples, the anchor UE may transmit the indication of one or more candidate resources the ambient wireless device may use to backscatter the sidelink data message. In either example, the ambient wireless device may select a resource from the one or more candidate resources and backscatter the sidelink data message to the UE using the selected resource. In response, the UE may transmit a feedback message that may be a data packet including feedback information for the sidelink data message. By operating in accordance with sidelink procedures described herein, the ambient wireless device may more reliably perform sidelink communications with other wireless devices in a system. As such, efficiency and reliability of communicating via sidelink in the system may increase.

Aspects of the disclosure are initially described in the context of wireless communications systems, network architecture, and process flows. Aspects of the disclosure are further illustrated by and described with reference to apparatus diagrams, system diagrams, and flowcharts that relate to resource allocation and communication techniques for ambient wireless devices.

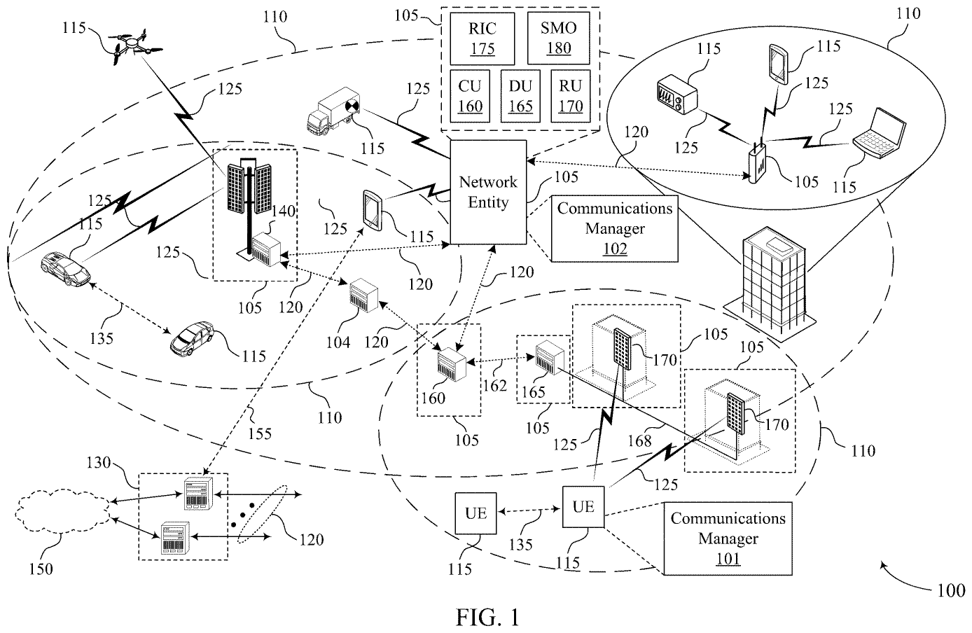

FIG. 1 shows an example of a wireless communications system 100 that supports resource allocation and communication techniques for ambient wireless devices in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, a NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature, and may include a network entity communications manager 102. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs) using UE communications manager 101.

The UEs 115 may be dispersed throughout a coverage area 110 of the wireless communications system 100, and each UE 15 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support resource allocation and communication techniques for ambient wireless devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an IoT device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or DFT-S-OFDM). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. HARQ feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FRI is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ 71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A UE 115 and an ambient wireless device may communicate via sidelink, according to the techniques described herein. For example, an associated network (e.g., a network device such as a network entity 105) may transmit a control message to the UE 115 and ambient wireless device, which indicates a resource pool allocation. A resource pool may include an aggregated collection of resources (e.g., time and frequency resources) that the UE 115 and ambient wireless device may use to communicate via sidelink. For example, the resource pool allocation may indicate a set of one or more resources associated with backscattering communications (e.g., resources that the ambient wireless device may use to send a backscattered signal of a received continuous waveform).

In some examples, the UE 115 may use the resources of the resource pool to transmit a sidelink data message to the ambient wireless device. Additionally, the UE 115 may transmit an indication of a feedback resource from the resource pool allocation that the ambient wireless device may use to send feedback for the received sidelink data message. In some examples, the feedback may be a HARQ-ACK that acknowledges receipt of the sidelink data message. As such, the UE 115 or a second UE 115 (e.g., an anchor UE 115) may transmit a continuous waveform that the ambient wireless device may use to backscatter the feedback. For example, the ambient wireless device may modulate the continuous waveform with feedback information (e.g., a set of bits pertaining to feedback for the sidelink data message). As such, the ambient wireless device may send a backscattered signal of the continuous waveform modulated with the feedback information.

In some examples, the ambient wireless device may send a sidelink data message to the UE 115. In some examples, the ambient wireless device may transmit a backscatter request message (e.g., an RTB) to the UE 115 and the UE 115 may transmit an indication of one or more candidate resources the ambient wireless device may use to backscatter the sidelink data message. In some other examples, the second UE 115 may transmit the indication of one or more candidate resources the ambient wireless device may use to backscatter the sidelink data message. In either example, the ambient wireless device may select a resource from the one or more candidate resources and backscatter the sidelink data message to the UE 115 using the selected resource. In response, the UE 115 may transmit a feedback message that may be a data packet including feedback information for the sidelink data message.

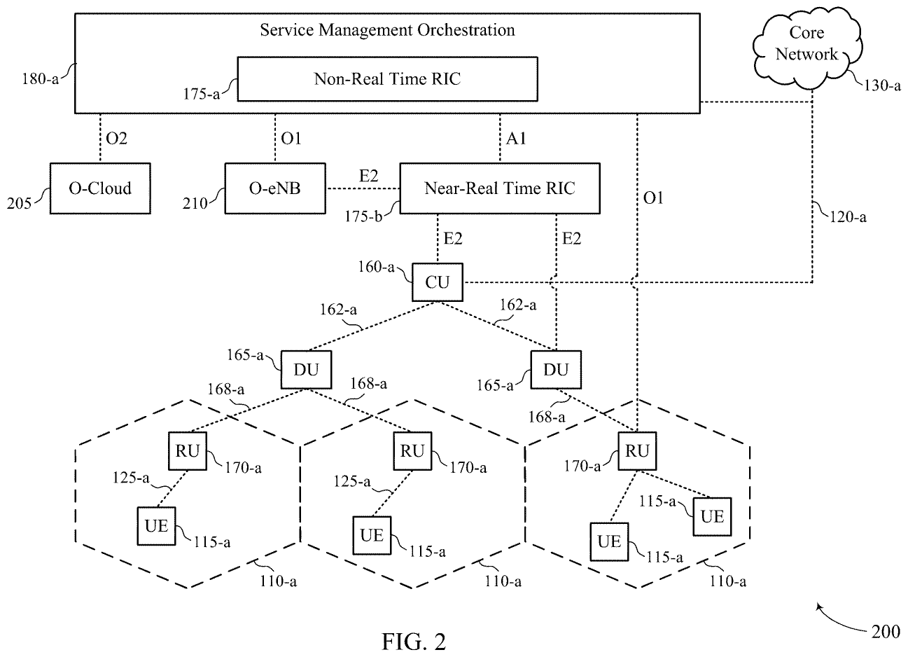

FIG. 2 shows an example of a network architecture 200 (e.g., a disaggregated base station architecture, a disaggregated RAN architecture) that supports resource allocation and communication techniques for ambient wireless devices in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, in some instances, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements (or targets), which may be managed via an operations and maintenance interface (e.g., an Ol interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled with or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

A UE 115-a and an ambient wireless device may communicate via sidelink, according to the techniques described herein. For example, an associated network (e.g., a network device such as a network entity 105) may transmit a control message to the UE 115-a and ambient wireless device, which indicates a resource pool allocation. A resource pool may include an aggregated collection of resources (e.g., time and frequency resources) that the UE 115-a and ambient wireless device may use to communicate via sidelink. For example, the resource pool allocation may indicate a set of one or more resources associated with backscattering communications (e.g., resources that the ambient wireless device may use to send a backscattered signal of a received continuous waveform).

In some examples, the UE 115-a may use the resources of the resource pool to transmit a sidelink data message to the ambient wireless device. Additionally, the UE 115-a may transmit an indication of a feedback resource from the resource pool allocation that the ambient wireless device may use to send feedback for the received sidelink data message. In some examples, the feedback may be a HARQ-ACK that acknowledges receipt of the sidelink data message. As such, the UE 115-a or a second UE 115-a (e.g., an anchor UE 115-a) may transmit a continuous waveform that the ambient wireless device may use to backscatter the feedback. For example, the ambient wireless device may modulate the continuous waveform with feedback information (e.g., a set of bits pertaining to feedback for the sidelink data message). As such, the ambient wireless device may send a backscattered signal of the continuous waveform modulated with the feedback information.

In some examples, the ambient wireless device may send a sidelink data message to the UE 115-a. In some examples, the ambient wireless device may transmit a backscatter request message (e.g., an RTB) to the UE 115-a and the UE 115-a may transmit an indication of one or more candidate resources the ambient wireless device may use to backscatter the sidelink data message. In some other examples, the second UE 115-a may transmit the indication of one or more candidate resources the ambient wireless device may use to backscatter the sidelink data message. In either example, the ambient wireless device may select a resource from the one or more candidate resources and backscatter the sidelink data message to the UE 115-a using the selected resource. In response, the UE 115-a may transmit a feedback message that may be a data packet including feedback information for the sidelink data message.

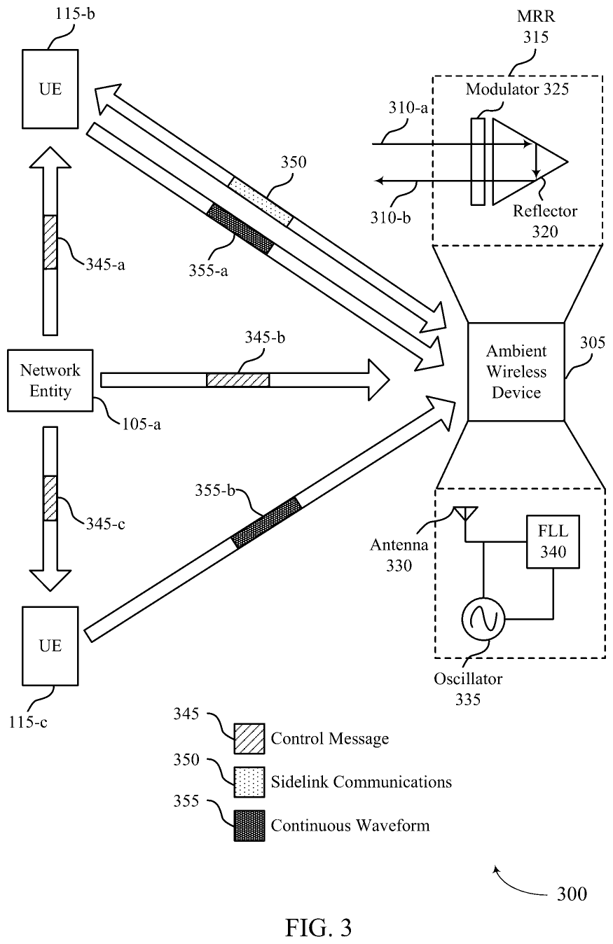

FIG. 3 shows an example of a wireless communications system 300 that supports resource allocation and communication techniques for ambient wireless devices (e.g., an ambient-IoT device) in accordance with one or more aspects of the present disclosure. In some examples, the wireless communications system 300 may support aspects of a wireless communications systems 100 and network architecture 200. For example, the wireless communications system 300 may include a network entity 105-a, a UE 115-b, and a UE 115-c, which may be respective examples of a network entity 105 and UEs 115, as described with reference to FIGS. 1 and 2. Further, wireless communications system 300 may include an ambient wireless device 305, which may be an example of a UE 115 with reference to FIGS. 1 and 2.

In some examples, the ambient wireless device 305 may be an example of an RFID tag which may communicate with the UE 115-b, the UE 115-c, or both via a continuous waveform 355 (e.g., forward link) and a backscattered signal (e.g., backward link). As such, the ambient wireless device 305 may be one or more types of an RFID tag. Systems that support communications between the UE 115-b, the ambient wireless device 305, and the UE 115-c may be referred to as RFID systems and may operate in ISM bands, NR licensed bands, or NR-U bands.

In some examples, the ambient wireless device 305 may be a passive device which may be a light weight IoT device with no battery. As such, the passive device may capture power from a radio wave (e.g., such as the continuous waveform 355) and use radio frequency backscatter communications to communicate with the UE 115-b. For example, the ambient wireless device 305 may include a modulated retro reflector (MRR) 315, which may allow the ambient wireless device 305 to reflect and modulate received optical beams 310 (e.g., at a high bandwidth). The MRR 315 may include a modulator 325 and a reflector 320. There may be many different types of modulators 325 such as deformable micro-electro-mechanical systems (MEMs), liquid crystals, electro-optic phase modulators, and multiple quantum wells (MQW). Further, there may be many different types of reflectors 320 such as corner cube or cat's eye. The ambient wireless device 305 may receive an optical beam 310 from the UE 115-b and change the direction of the optical beam 310 using the reflector 320 (e.g., reflect the optical beam 310 in a same or similar direction in which it was received). The reflected optical beam 310 (e.g., an optical beam 310-a) may pass through the modulator 325 and the modulated optical beam 310 (e.g., the modulated optical beam 310-b) may continue in the direction dictated by the reflector 320. In such examples, the modulated optical beam 310 may be an example of a backscattered signal.

In some examples, the ambient wireless device 305 may be a semi-passive device, which may be a light weight IoT device that uses radio frequency backscatter communications to communicate with the UE 115-b. In some cases, the semi-passive device may include a battery or a capacitor that may be rechargeable. Additionally, or alternately, the semi-passive device may perform energy harvesting (e.g., harvest energy from received wireless transmissions, harvest energy from wind power, harvest energy from solar power, or the like) and store the harvested energy in energy storage circuits. Additionally, or alternatively, the semi-passive device may include a power amplifier that may be embedded in a reception component of the device or a transmission component of the device.

In some examples, the ambient wireless device 305 may be a semi-active device, which may be light weight IoT device, that uses radio frequency backscatter communications to communicate with the UE 115-b. Additionally, or alternatively, the semi-active device may perform active communications. For example, the ambient wireless device 305 may receive wireless transmissions at an antenna 330 and transmit a response to the wireless transmissions using the antenna 330. As such, the semi-active device may include a battery that may be rechargeable or may perform energy harvesting and store the harvested energy in energy storage circuits.

In some examples, the ambient wireless device 305 may be an active device which may be a light weight IoT device, that uses active communications to communicate with the UE 115-b. As such, the active device may include a battery that may be rechargeable or may perform energy harvesting and store the harvested energy in energy storage circuits.

As illustrated in FIG. 3, the ambient wireless device 305 may include an oscillator 335 which may be used to generate transmissions (e.g., backscattering, or active transmissions) from the ambient wireless device 305 to the UE 115-b. For instance, the oscillator 335 may be tuned, such that the transmissions are generated in a given frequency range. In some examples, the ambient wireless device 305 may include a frequency lock loop (FLL) 340. The FLL 340 may be a circuit that compares the frequency of the oscillator 335 to a reference frequency and may automatically raise or lower the frequency of the oscillator 335 until the frequency of the oscillator 335 matches that of the reference frequency.

In some cases, 5G communications may be expanded to support ambient IoT devices (e.g., URLLC and MTC). In some cases, however, 5G communications may not support ambient IoT devices for one or more use cases, such as asset management, logistics, warehousing, and manufacturing, among other examples. As such one or more types of wireless communications may be configured to manage ambient devices (e.g., future deployments of 5G, 6G, among other examples). Such wireless communications may be configured to include network entities 105 and UEs 115 that may read and write information stored on ambient IoT devices, provide energy to ambient IoT devices, and read information-bearing signals reflected by ambient IoT devices.

As such, it may be advantageous for the ambient IoT devices to communicate with one or more network devices using sidelink based communications. In some cases, however, ambient IoT devices may not be configured to perform sensing, resource selection, and sidelink transmission independent of other network devices, which may limit the capabilities of a sidelink communications for ambient IoT devices.

As such, the techniques described herein may support sidelink procedures for ambient-IoT devices communicating through backscattering. For example, one or more procedures may support ambient IoT devices reporting backscattering capability to network devices, network devices transmitting excitation signals (e.g., continuous waveforms 355) to the ambient IoT devices, and network devices requesting communication from the ambient IoT devices. Additionally, or alternatively, the procedures may include resource configuration for backscattered based sidelink communications, resource selection, continuous waveform 355 transmission, IoT device discovery, and feedback messaging for sidelink.

In some examples, the UE 115-b, the ambient wireless device 305, and the UE 115-c may perform backscattered based sidelink communications 350 using one or more configured resource pools. For example, the network entity 105-a (e.g., or another network device) may transmit a control message 345 to the UE 115-b, the ambient wireless device 305, and the UE 115-c. The control message 345 may indicate a resource pool allocation that includes a set of resources for backscatter communications between the ambient wireless device 305 and the UE 115-b and 115-c. In some examples, the UE 115-b, the ambient wireless device 305, and the UE 115-c may use the set of resources indicated in the resource pool allocation to perform sidelink communications 350. In some examples, the network entity 105-a may transmit the control message 345 via unicast, broadcast, or groupcast. In some examples, each device may receive a respective control message 345 that includes a resource pool allocation specific to the receiving device. For instance, the UE 115-b may receive a control message 345-a, the ambient wireless device 305 may receive a control message 345-b, and the UE 115-c may receive a control message 345-c.

In some cases, the ambient wireless device 305 may use the resource pool allocation to receive a sidelink data message from the UE 115-b, and in response, send feedback information. In such cases, the sidelink communications 350 may include the UE 115-b transmitting a sidelink data message to the ambient wireless device 305, using a resource from the resource pool allocation. As such, the ambient wireless device 305 may determine feedback information to send in response to the sidelink data message. The ambient wireless device 305 may receive a continuous waveform 355 and modulate the continuous waveform 355 with the feedback information, and send to the UE 115-b a backscattered signal of the continuous waveform 355 modulated with the feedback information for the sidelink data message.

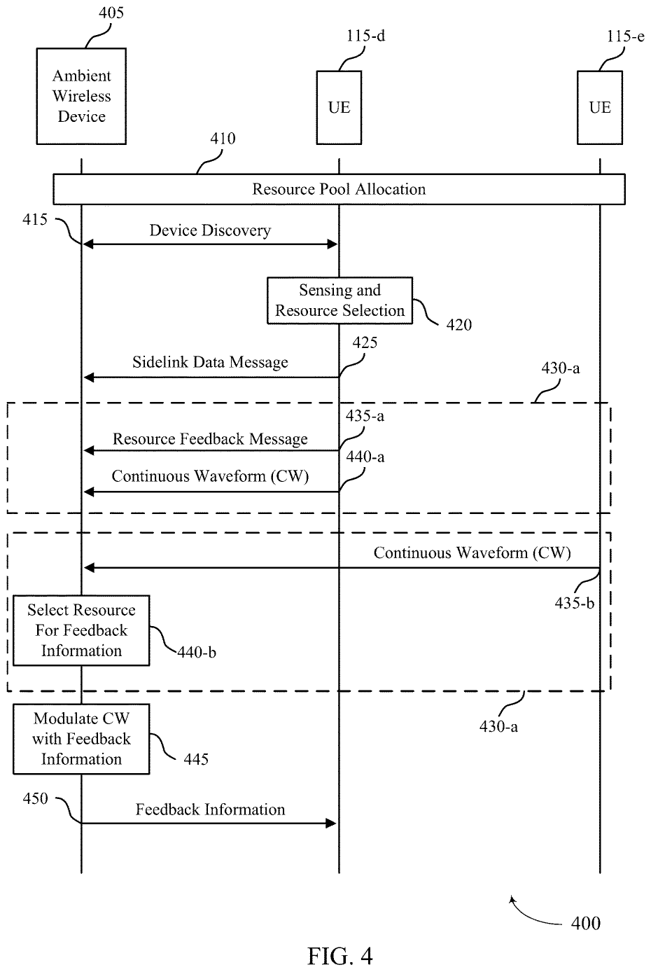

The ambient wireless device 305 may receive the continuous waveform 355 from the UE 115-b or the UE 115-c. For instance, if the UE 115-b supports a full-duplex mode, the UE 115-b may concurrently transmit a continuous waveform 355-a and receive the backscattered signal of the continuous waveform 355-a modulated with the feedback information. If, however, the UE 115-b is not operating in a full-duplex mode, the UE 115-c may transmit a continuous waveform 355-b, and the UE 115-b may receive the backscattered signal of the continuous waveform 355-b modulated with the feedback information. As such, the UE 115-c may be an example of a supporting UE (e.g., an anchor UE) that provides the continuous waveform 355-b on behalf of the UE 115-b. Further discussion of the ambient wireless device 305 receiving a sidelink data message and responding with feedback information is described herein, including with reference to FIG. 4.

In some cases, the ambient wireless device 305 may use the resource pool allocation to transmit a sidelink data message to the UE 115-b and receive a feedback message from the UE 115-b. In such cases, the sidelink communications 350 may include the ambient wireless device 305 selecting a resource to transmit the sidelink data message, modulating a received continuous waveform 355 with the sidelink data message, sending to the UE 115-b a backscattered signal of the continuous waveform 355 modulated with the sidelink data message, and receiving a feedback message for the sidelink data message from the UE 115-b.

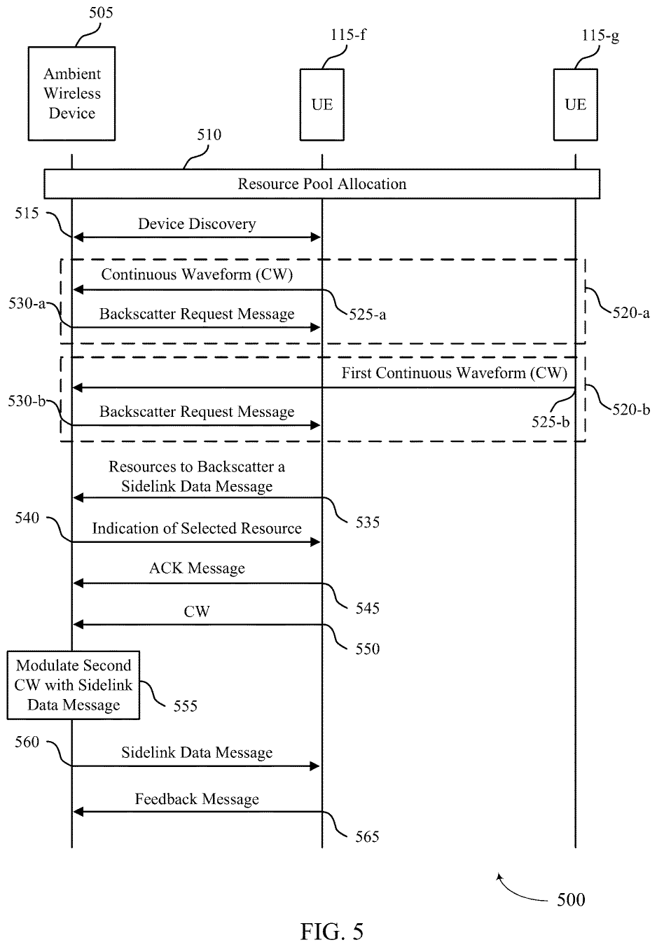

In some examples, the ambient wireless device 305 may initiate sending the sidelink data message by sending a request to backscatter message to the UE 115-b. In such examples, the UE 115-b may indicate a set of resources which the ambient wireless device 305 may use to select the resource to transmit the sidelink data message to the UE 115-b. Further discussion of the ambient wireless device 305 receives the set of sidelink resources from the UE 115-b are described herein, including with reference to FIG. 5.

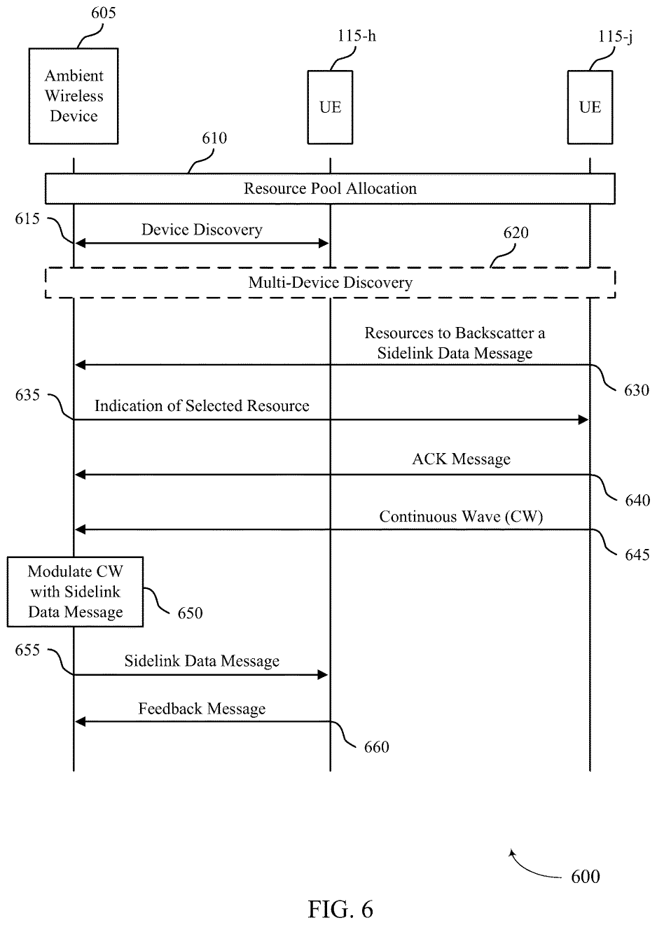

In some other examples, the UE 115-c may indicate a set of resources which the ambient wireless device 305 may use to select the resource to transmit the sidelink data message to the UE 115-b. Further discussion of the ambient wireless device 305 receiving the set of sidelink resources from the UE 115-c are described herein, including with reference to FIG. 6.

FIG. 4 shows an example of a process flow 400 that supports resource allocation and communication techniques for ambient wireless devices in accordance with one or more aspects of the present disclosure. In some examples, process flow 400 may implement aspects of wireless communications system 100 and 300. Process flow 400 includes a UE 115-d and 115-e which may be examples of UEs 115, as described with reference to FIGS. 1 through 3. Additionally, ambient wireless device 405 may be an example of ambient wireless device 305, as described with reference to FIG. 3. Alternative examples of the following may be implemented, where some steps are performed in a different order than described, or are not performed at all. In some cases, steps may include additional features not mentioned below, or further steps may be added. In addition, while process flow 400 shows processes between a two UEs 115 and the ambient wireless device 405, it should be understood that these processes may occur between any quantity of network devices and network device types.

At 410, the ambient wireless device 405, UE 115-d, and UE 115-e may receive a control message (e.g., control message 345, with reference to FIG. 3). In some examples, the control message may indicate a resource pool allocation for each of the devices. In some examples, the ambient wireless device 405 and the UEs 115 may use the resource pool allocation to perform backscattered and sidelink communications. For example, the control message may indicate whether the resource pool supports backscatter communications (e.g., includes resources for backscattering), whether the resource pool supports sidelink communications (e.g., includes resources for sidelink), or both. In some examples, the control message may indicate a first resource pool that includes resources for backscattering and a second resource pool that includes resources for sidelink communications. Additionally, or alternatively, the control message may indicate one pool for that includes resources for both backscattering and sidelink.

If the control message indicates that the resource pool allocation is for both backscattering and sidelink communications, the control message may indicate a basic frequency unit associated with the resources, a frequency range associated with the resources, or both. Additionally, or alternatively, the control message may indicate a guard band between the set of resources for backscattered communications and the set of resources for sidelink communications.

At 415, the UE 115-d and the ambient wireless device 405 may perform a device discovery procedure, to establish wireless communications between the UE 115-d and the ambient wireless device 405. For example, the UE 115-d may transmit a continuous waveform to the ambient wireless device 405 for the discovery procedure. The ambient wireless device 405 may modulate the continuous waveform with an ACK of the discovery procedure. As such, the ambient wireless device 405 may send, as part of the discovery procedure, a backscattered signal of the continuous waveform modulated with the ACK of the discovery procedure. Based on performing the device discovery procedure, the UE 115-d, and the ambient wireless device 405 may establish a wireless connection (e.g., via a communication link).

At 420, the UE 115-d may determine to transmit a sidelink data message to the ambient wireless device 405. As such, the UE 115-d may perform a resource sensing and selection procedure to identify a first resource to transmit the sidelink data message. In some examples, the UE 115-d may select the first resource for the sidelink data message from the set of resources indicated in the resource pool allocation.

At 425, the UE 115-d may transmit to the ambient wireless device 405 the sidelink data message via the first resource selected from the resource pool allocation.

In some cases, the ambient wireless device 405 may determine feedback information to send back to the UE 115-d in response to the sidelink data message. The ambient wireless device 405 may prepare a backscattered signal that includes the sidelink information in accordance with one or more procedures.

In some examples, the ambient wireless device 405 may prepare the backscattered signal in accordance with the operations of procedure 430-a. For example, at 435-a, the ambient wireless device 405 may receive from the UE 115-d a feedback resource message indicating that a second resource of the resource pool allocation is allocated for the ambient wireless device 405 to provide feedback for the sidelink data message. At 440-a, the ambient wireless device 405 may receive from the UE 115-d a continuous waveform via a third of the resource pool allocation. The continuous waveform may be for activation of the ambient wireless device 405 to provide feedback for the sidelink data message. In some cases, the ambient wireless device 405 and the UE 115-d may use procedure 430-a in examples where the UE 115-d operates in accordance with a full-duplex mode. While operating in the full-duplex mode, the UE 115-d may concurrently transmit the continuous waveform and receive a backscattered signal of the continuous waveform modulated with feedback information from the ambient wireless device 405.

In some examples, the ambient wireless device 405 may prepare the backscattered signal in accordance with the operations of procedure 430-b. For example, at 435-b, the ambient wireless device 405 may receive from the UE 115-e a continuous waveform via a second resource of the resource pool allocation. The continuous waveform may be for activation of the ambient wireless device 405 to provide feedback for the sidelink data message. At 440-b, the ambient wireless device 405 may select a resource (e.g., a HARQ-ACK resource) to use to send the UE 115-d a backscattered signal of the continuous waveform modulated with the feedback information for the sidelink data message. In some examples, the control message at 410 may configure a common HARQ-ACK resource to use to send any feedback, and define a mapping rule between the resource used to transmit the sidelink data message and the common HARQ-ACK resource. The ambient wireless device 405 and the UE 115-e may use procedure 430-b in examples where the UE 115-d does not operate in accordance with a full-duplex mode. That is, the UE 115-e may transmit the continuous waveform concurrently to the UE 115-d receiving the backscattered signal of the continuous waveform modulated with feedback information from the ambient wireless device 405. As such, the UE 115-e may act as an anchor UE (e.g., a support UE) to the UE 115-d and the ambient wireless device 405.

At 445, the ambient wireless device 405 may modulate the continuous waveform (e.g., received at 440-a or 435-b) with the feedback information for the sidelink data message.

At 450, the ambient wireless device 405 may send to the UE 115-d the backscattered signal of the continuous waveform modulated with the feedback information for the sidelink data message. The ambient wireless device 405 may send the backscattered signal using the resource identified in the procedure 430 used. For example, if the ambient wireless device 405 operates via procedure 430-a, the ambient wireless device 405 may send the backscattered signal using the resource indicated in the resource feedback message, at 435-a. If the ambient wireless device 405 operates via procedure 430-b, the ambient wireless device 405 may send the backscattered signal using the common HARQ-ACK resource selected, at 440-b.

FIG. 5 shows an example of a process flow 500 that supports resource allocation and communication techniques for ambient wireless devices in accordance with one or more aspects of the present disclosure. In some examples, process flow 500 may implement aspects of wireless communications system 100 and 300. Process flow 500 includes a UE 115-f and 115-g which may be examples of UEs 115, as described with reference to FIGS. 1 through 4. Additionally, ambient wireless device 505 may be an example of ambient wireless device 505 305 and ambient wireless device 505 405, as described with reference FIGS. 3 and 4. Alternative examples of the following may be implemented, where some steps are performed in a different order than described, or are not performed at all. In some cases, steps may include additional features not mentioned below, or further steps may be added. In addition, while process flow 500 shows processes between a two UEs 115 and the ambient wireless device 505, it should be understood that these processes may occur between any quantity of network devices and network device types.

At 510, the ambient wireless device 505, UE 115-f, and UE 115-g may receive a control message (e.g., control message 345, with reference to FIG. 3). In some examples, the control message may indicate a resource pool allocation for each of the devices. In some examples, the ambient wireless device 505 and the UEs 115 may use the resource pool allocation to perform backscattered and sidelink communications. For example, the control message may indicate whether the resource pool supports backscatter communications (e.g., includes resources for backscattering), whether the resource pool supports sidelink communications (e.g., includes resources for sidelink), or both. In some examples, the control message may indicate a first resource pool that includes resources for backscattering and a second resource pool that includes resources for sidelink communications. Additionally, or alternatively, the control message may indicate one pool for that includes resources for both backscattering and sidelink.

If the control message indicates that the resource pool allocation is for both backscattering and sidelink communications, the control message may indicate a basic frequency unit associated with the resources, a frequency range associated with the resources, or both. Additionally, or alternatively, the control message may indicate a guard band between the set of resources for backscattered communications and the set of resources for sidelink communications.

At 515, the UE 115-f and the ambient wireless device 505 may perform a device discovery procedure, to establish wireless communications between the UE 115-f and the ambient wireless device 505. For example, the UE 115-f may transmit a continuous waveform to the ambient wireless device 505 for the discovery procedure. The ambient wireless device 505 may modulate the continuous waveform with capability information of the ambient wireless device 505. As such, the ambient wireless device 505 may send, as part of the discovery procedure, a backscattered signal of the continuous waveform modulated with the capability information. In some examples, the capability information may include capability of frequency shifting at the ambient wireless device 505, whether the ambient wireless device 505 includes a band pass filter, or both. Based on performing the device discovery procedure, the UE 115-f, and the ambient wireless device 505 may establish a wireless connection (e.g., via a communication link).

In some examples, the ambient wireless device 505 may determine to send a sidelink data message to the UE 115-f. As such, the ambient wireless device 505 may send to the UE 115-f, a request to backscatter in accordance with a procedure 520-a or a procedure 520-b.

For example, the devices of process flow 500 may determine to operate in accordance with procedure 520-a. At 525-a, the ambient wireless device 505 may receive from the UE 115-f, a first continuous waveform for activation of the ambient wireless device 505 to perform backscatter communications. The ambient wireless device 505 may modulate the first continuous waveform with a backscatter request message. In some examples, the backscatter request message may include a request for one or more resources for the ambient wireless device 505 to send a sidelink data message. At 530-a, the ambient wireless device 505 may send to the UE 115-f via a resource of the resource pool allocation, a backscattered signal of the first continuous waveform modulated with the backscatter request message.

Additionally, or alternatively, the devices of process flow 500 may determine to operate in accordance with procedure 520-b. At 525-b, the ambient wireless device 505 may receive from the UE 115-g, a first continuous waveform for activation of the ambient wireless device 505 to perform backscatter communications. The ambient wireless device 505 may modulate the first continuous waveform with a backscatter request message. In some examples, the backscatter request message may include a request for one or more resources for the ambient wireless device 505 to send a sidelink data message. At 530-b, the ambient wireless device 505 may send to the UE 115-f, via a resource of the resource pool allocation, a backscattered signal of the first continuous waveform modulated with the backscatter request message. In examples for procedure 520-b, the UE 115-g may perform operations as an anchor UE (e.g., a support UE) to the UE 115-f.

In some examples of both procedure 520-a and 520-b, the resource used to send the backscatter request message may be allocated for the ambient wireless device 505 to send one or more backscatter request messages. For example, the resource may be common to a set of ambient wireless devices or may be a resource of a communication link associated with the ambient wireless device 505. Additionally, or alternatively, the resource may be allocated to the ambient wireless device 505 in the control message, at 510.

At 535, the UE 115-f may transmit an indication of one or more resources of the resource pool allocation for the ambient wireless device 505 to use to backscatter a sidelink data message (e.g., candidate resources). The UE 115-f may sense and select the candidate resources based on one or more capabilities of the ambient wireless device 505 (e.g., indicated to the UE 115-f during device discovery, at 515). If the ambient wireless device 505 supports a frequency shift above a threshold value, the UE 115-f may sense and select two resources (e.g., a first for a continuous waveform transmission and a second for backscattering at the ambient wireless device 505). If the ambient wireless device 505 does not support or is not associated with a band-pass filter, the UE 115-f may refrain from selecting candidate resources associated with frequency division multiplexing (FDM). If the ambient wireless device 505 has a band-pass filter, the UE 115-f may select candidate resources that have a bandwidth greater than the band-pass filter.

At 540, the ambient wireless device 505 may send to the UE 115-f an indication of which of the candidate resources the ambient wireless device 505 has selected to send the sidelink data message. In some examples, the ambient wireless device 505 may send the indication of the selected resource using a backscattered signal of a continuous waveform, where the continuous waveform may be received from the UE 115-f or the UE 115-g.

At 545, the ambient wireless device 505 may receive from the UE 115-f, an ACK message for the indication of the selected resource.

At 550, the ambient wireless device 505 may receive from the UE 115-f, a continuous waveform for sidelink communications from the ambient wireless device 505. That is, the ambient wireless device 505 may use the waveform to send a sidelink data message to the UE 115-f.

At 555, the ambient wireless device 505 may modulate the continuous waveform with the sidelink data message.

At 560, the ambient wireless device 505 may send to the UE 115-f, via the selected resource (e.g., indicated, at 540), a backscattered signal of the continuous waveform modulated with the sidelink data message.

At 565, the ambient wireless device 505 may receive from the UE 115-f, a feedback message that included feedback information associated with the sidelink data message. In some examples, the feedback message may include a HARQ-ACK, which acknowledges receipt of the sidelink data message at the UE 115-f. In some examples, the HARQ-ACK may be amplitude shift keying (ASK) based. In some examples, the resource associated with the HARQ-ACK may be included in the resource pool allocation.

FIG. 6 shows an example of a process flow 600 that supports resource allocation and communication techniques for ambient wireless devices in accordance with one or more aspects of the present disclosure. In some examples, process flow 600 may implement aspects of wireless communications system 100 and 300. Process flow 600 includes a UE 115-h and 115-j which may be examples of UEs 115, as described with reference to FIGS. 1 through 5. Additionally, ambient wireless device 605 may be an example of ambient wireless device 305, 405, and 505, as described with reference FIGS. 3 through 5. Alternative examples of the following may be implemented, where some steps are performed in a different order than described, or are not performed at all. In some cases, steps may include additional features not mentioned below, or further steps may be added. In addition, while process flow 600 shows processes between a two UEs 115 and the ambient wireless device 605, it should be understood that these processes may occur between any quantity of network devices and network device types.

At 610, the ambient wireless device 605, UE 115-h, and UE 115-j may receive a control message (e.g., control message 345, with reference to FIG. 3). In some examples, the control message may indicate a resource pool allocation for each of the devices. In some examples, the ambient wireless device 605 and the UEs 115 may use the resource pool allocation to perform backscattered and sidelink communications. For example, the control message may indicate whether the resource pool supports backscatter communications (e.g., includes resources for backscattering), whether the resource pool supports sidelink communications (e.g., includes resources for sidelink), or both. In some examples, the control message may indicate a first resource pool that includes resources for backscattering and a second resource pool that includes resources for sidelink communications. Additionally, or alternatively, the control message may indicate one pool for that includes resources for both backscattering and sidelink.

If the control message indicates that the resource pool allocation is for both backscattering and sidelink communications, the control message may indicate a basic frequency unit associated with the resources, a frequency range associated with the resources, or both. Additionally, or alternatively, the control message may indicate a guard band between the set of resources for backscattered communications and the set of resources for sidelink communications.

At 615, the UE 115-h and the ambient wireless device 605 may perform a device discovery procedure, to establish wireless communications between the UE 115-h and the ambient wireless device 605. For example, the UE 115-h may transmit a continuous waveform to the ambient wireless device 605 for the discovery procedure. The ambient wireless device 605 may modulate the continuous waveform with capability information of the ambient wireless device 605. As such, the ambient wireless device 605 may send, as part of the discovery procedure, a backscattered signal of the continuous waveform modulated with the capability information. In some examples, the capability information may include capability of frequency shifting at the ambient wireless device 605, whether the ambient wireless device 605 includes a band pass filter, or both. Based on performing the device discovery procedure, the UE 115-h and the ambient wireless device 605 may establish a wireless connection (e.g., via a communication link).

In some examples, at 620, the devices of process flow 600 may perform a multi-device discovery. In such examples, the ambient wireless device 605 may additionally send to UE 115-j, the backscattered signal of the continuous waveform modulated with the capability information. Additionally, or alternatively, the UE 115-h and the UE 115-j may communicate respective capability information. Based on the respective capability information, the UE 115-j may determine to serve as an anchor UE (e.g., a support UE) to the UE 115-h. That is, the UE 115-j may communicate one or signals to the ambient wireless device 605 which may configure ambient wireless device 605 to communicate one or more sidelink messages with the UE 115-h. In some cases, the UE 115-j may determine to serve as an anchor UE based on the UE 115-h indicating that the UE 115-h does not operate in accordance with a full-duplex mode.

At 630, the UE 115-j may transmit an indication of one or more resources of the resource pool allocation for the ambient wireless device 605 to use to backscatter a sidelink data message (e.g., candidate resources). The UE 115-j may sense and select the candidate resources based on one or more capabilities of the ambient wireless device 605 (e.g., indicated to the UE 115-j during multi-device discovery, at 620). If the ambient wireless device 605 supports a frequency shift above a threshold value, the UE 115-j may sense and select two candidate resources (e.g., a first for a continuous waveform transmission and a second for backscattering at the ambient wireless device 605). If the ambient wireless device 605 does not support or is not associated with a band-pass filter, the UE 115-j may refrain from selecting candidate resources associated with FDM. If the ambient wireless device 605 has a band-pass filter, the UE 115-j may select candidate resources that have a bandwidth greater than the band-pass filter. In some examples, the UE 115-j may transmit multiple sets of one or more candidate resources to respective ambient wireless devices 605 (e.g., via broadcast, groupcast, or unicast).

At 635, the ambient wireless device 605 may send to the UE 115-j an indication of which of the candidate resources the ambient wireless device 605 has selected to send the sidelink data message. In some examples, the ambient wireless device 605 may send the indication of the selected resource using a backscattered signal of a continuous waveform, where the continuous waveform may be received from the UE 115-h or the UE 115-j.

At 640, the ambient wireless device 605 may receive from the UE 115-j, an ACK message for the indication of the selected resource.

At 645, the ambient wireless device 605 may receive from the UE 115-j, a continuous waveform for sidelink communications between the ambient wireless device 605 and the UE 115-h. That is, the ambient wireless device 605 may use the waveform to send a sidelink data message to the UE 115-h.

At 650, the ambient wireless device 605 may modulate the continuous waveform with the sidelink data message.

At 655, the ambient wireless device 605 may send to the UE 115-h, via the selected resource (e.g., indicated, at 640), a backscattered signal of the continuous waveform modulated with the sidelink data message.

At 660, the ambient wireless device 605 may receive from the UE 115-h, a feedback message that included feedback information associated with the sidelink data message. In some examples, the feedback message may include a HARQ-ACK, which acknowledges receipt of the sidelink data message at the UE 115-h. In some examples, the HARQ-ACK may be ASK based. In some examples, the resource associated with the HARQ-ACK may be included in the resource pool allocation.

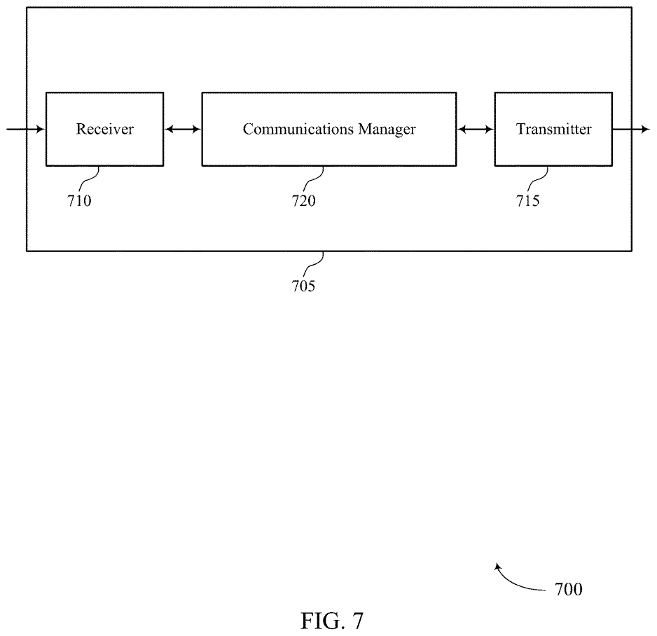

FIG. 7 shows a block diagram 700 of a device 705 that supports resource allocation and communication techniques for ambient wireless devices in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to resource allocation and communication techniques for ambient wireless devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to resource allocation and communication techniques for ambient wireless devices). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of resource allocation and communication techniques for ambient wireless devices as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a control message that indicates a resource pool allocation for the ambient wireless device, the resource pool allocation including a set of multiple resources for backscatter communications between the ambient wireless device and a UE. The communications manager 720 is capable of, configured to, or operable to support a means for receiving, from the UE, a sidelink data message via a first resource of the set of multiple resources based on the resource pool allocation. The communications manager 720 is capable of, configured to, or operable to support a means for receiving, via a second resource of the set of multiple resources, a continuous waveform for activation of the ambient wireless device to provide feedback for the sidelink data message. The communications manager 720 is capable of, configured to, or operable to support a means for modulating the continuous waveform with feedback information for the sidelink data message. The communications manager 720 is capable of, configured to, or operable to support a means for sending, via a third resource of the set of multiple resources, a backscattered signal of the continuous waveform modulated with the feedback information for the sidelink data message.

Additionally, or alternatively, the communications manager 720 may support wireless communications in accordance with examples as disclosed herein. For example, the communications manager 720 is capable of, configured to, or operable to support a means for receiving a control message that indicates a resource pool allocation for the UE, the resource pool allocation including a set of multiple resources for backscatter communications between the UE and an ambient wireless device. The communications manager 720 is capable of, configured to, or operable to support a means for transmitting, to the ambient wireless device, a sidelink data message via a first resource of the set of multiple resources based on the resource pool allocation. The communications manager 720 is capable of, configured to, or operable to support a means for transmitting, via a second resource of the set of multiple resources, a continuous waveform for activation of the ambient wireless device to provide feedback for the sidelink data message. The communications manager 720 is capable of, configured to, or operable to support a means for receiving, via a third resource of the set of multiple resources, a backscattered signal of the continuous waveform modulated with feedback information for the sidelink data message.

Additionally, or alternatively, the communications manager 720 may support wireless communications in accordance with examples as disclosed herein. For example, the communications manager 720 is capable of, configured to, or operable to support a means for receiving a control message that indicates a resource pool allocation for the second UE, the resource pool allocation including a set of multiple resources for backscatter communications for a first UE, the second UE, and an ambient wireless device. The communications manager 720 is capable of, configured to, or operable to support a means for transmitting, via a first resource of the set of multiple resources to the ambient wireless device, a continuous waveform for activation of the ambient wireless device for the ambient wireless device to provide feedback to the first UE.

Additionally, or alternatively, the communications manager 720 may support wireless communications in accordance with examples as disclosed herein. For example, the communications manager 720 is capable of, configured to, or operable to support a means for receiving a control message that indicates a resource pool allocation for the ambient wireless device, the resource pool allocation including a set of multiple resources for backscatter communications between the ambient wireless device and a UE. The communications manager 720 is capable of, configured to, or operable to support a means for receiving an indication of one or more resources of the set of multiple resources for the ambient wireless device to use to backscatter a sidelink data message. The communications manager 720 is capable of, configured to, or operable to support a means for receiving, via a first resource of the one or more resources, a continuous waveform for sidelink communications from the ambient wireless device. The communications manager 720 is capable of, configured to, or operable to support a means for modulating the continuous waveform with the sidelink data message. The communications manager 720 is capable of, configured to, or operable to support a means for sending, via a second resource of the one or more resources, a backscattered signal of the continuous waveform modulated with the sidelink data message.

Additionally, or alternatively, the communications manager 720 may support wireless communications in accordance with examples as disclosed herein. For example, the communications manager 720 is capable of, configured to, or operable to support a means for receiving a control message that indicates a resource pool allocation for the UE, the resource pool allocation including a set of multiple resources for backscatter communications between the UE and an ambient wireless device. The communications manager 720 is capable of, configured to, or operable to support a means for transmitting an indication of one or more resources of the set of multiple resources for the ambient wireless device to use to backscatter a sidelink data message. The communications manager 720 is capable of, configured to, or operable to support a means for transmitting, via a first resource of the one or more resources, a continuous waveform for sidelink communications at the ambient wireless device. The communications manager 720 is capable of, configured to, or operable to support a means for receiving, via a second resource of the one or more resources, a backscattered signal of the continuous waveform modulated with the sidelink data message.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, reduced power consumption, and a more efficient utilization of communication resources.

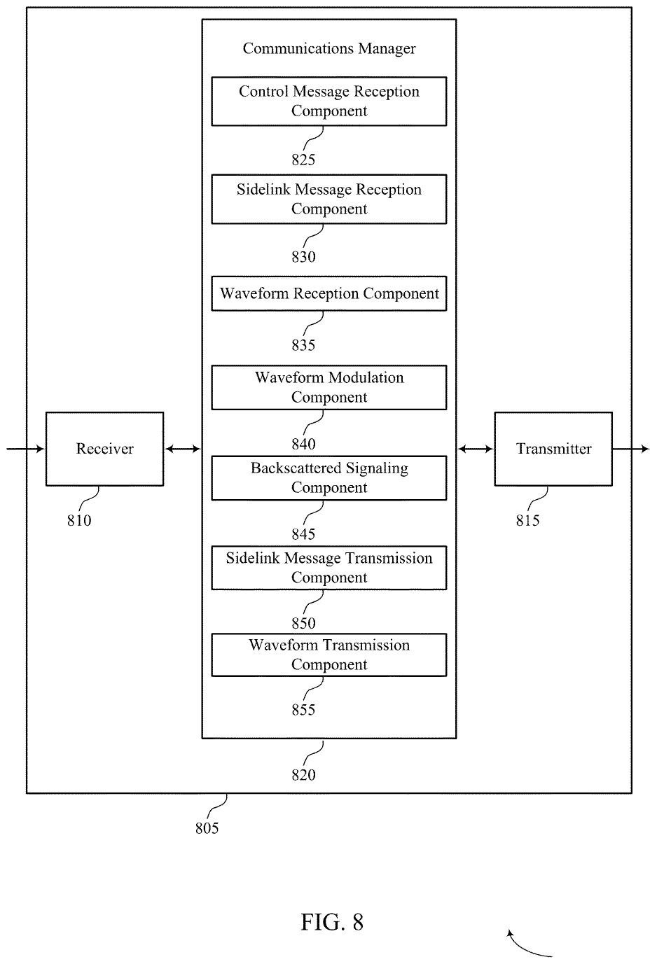

FIG. 8 shows a block diagram 800 of a device 805 that supports resource allocation and communication techniques for ambient wireless devices in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to resource allocation and communication techniques for ambient wireless devices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to resource allocation and communication techniques for ambient wireless devices). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of resource allocation and communication techniques for ambient wireless devices as described herein. For example, the communications manager 820 may include a control message reception component 825, a sidelink message reception component 830, a waveform reception component 835, a waveform modulation component 840, a backscattered signaling component 845, a sidelink message transmission component 850, a waveform transmission component 855, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The control message reception component 825 is capable of, configured to, or operable to support a means for receiving a control message that indicates a resource pool allocation for the ambient wireless device, the resource pool allocation including a set of multiple resources for backscatter communications between the ambient wireless device and a UE. The sidelink message reception component 830 is capable of, configured to, or operable to support a means for receiving, from the UE, a sidelink data message via a first resource of the set of multiple resources based on the resource pool allocation. The waveform reception component 835 is capable of, configured to, or operable to support a means for receiving, via a second resource of the set of multiple resources, a continuous waveform for activation of the ambient wireless device to provide feedback for the sidelink data message. The waveform modulation component 840 is capable of, configured to, or operable to support a means for modulating the continuous waveform with feedback information for the sidelink data message. The backscattered signaling component 845 is capable of, configured to, or operable to support a means for sending, via a third resource of the set of multiple resources, a backscattered signal of the continuous waveform modulated with the feedback information for the sidelink data message.

Additionally, or alternatively, the communications manager 820 may support wireless communications in accordance with examples as disclosed herein. The control message reception component 825 is capable of, configured to, or operable to support a means for receiving a control message that indicates a resource pool allocation for the UE, the resource pool allocation including a set of multiple resources for backscatter communications between the UE and an ambient wireless device. The sidelink message transmission component 850 is capable of, configured to, or operable to support a means for transmitting, to the ambient wireless device, a sidelink data message via a first resource of the set of multiple resources based on the resource pool allocation. The waveform transmission component 855 is capable of, configured to, or operable to support a means for transmitting, via a second resource of the set of multiple resources, a continuous waveform for activation of the ambient wireless device to provide feedback for the sidelink data message. The waveform reception component 835 is capable of, configured to, or operable to support a means for receiving, via a third resource of the set of multiple resources, a backscattered signal of the continuous waveform modulated with feedback information for the sidelink data message.

Additionally, or alternatively, the communications manager 820 may support wireless communications in accordance with examples as disclosed herein. The control message reception component 825 is capable of, configured to, or operable to support a means for receiving a control message that indicates a resource pool allocation for the second UE, the resource pool allocation including a set of multiple resources for backscatter communications for a first UE, the second UE, and an ambient wireless device. The waveform transmission component 855 is capable of, configured to, or operable to support a means for transmitting, via a first resource of the set of multiple resources to the ambient wireless device, a continuous waveform for activation of the ambient wireless device for the ambient wireless device to provide feedback to the first UE.

Additionally, or alternatively, the communications manager 820 may support wireless communications in accordance with examples as disclosed herein. The control message reception component 825 is capable of, configured to, or operable to support a means for receiving a control message that indicates a resource pool allocation for the ambient wireless device, the resource pool allocation including a set of multiple resources for backscatter communications between the ambient wireless device and a UE. The control message reception component 825 is capable of, configured to, or operable to support a means for receiving an indication of one or more resources of the set of multiple resources for the ambient wireless device to use to backscatter a sidelink data message. The waveform reception component 835 is capable of, configured to, or operable to support a means for receiving, via a first resource of the one or more resources, a continuous waveform for sidelink communications from the ambient wireless device. The waveform modulation component 840 is capable of, configured to, or operable to support a means for modulating the continuous waveform with the sidelink data message. The backscattered signaling component 845 is capable of, configured to, or operable to support a means for sending, via a second resource of the one or more resources, a backscattered signal of the continuous waveform modulated with the sidelink data message.

Additionally, or alternatively, the communications manager 820 may support wireless communications in accordance with examples as disclosed herein. The control message reception component 825 is capable of, configured to, or operable to support a means for receiving a control message that indicates a resource pool allocation for the UE, the resource pool allocation including a set of multiple resources for backscatter communications between the UE and an ambient wireless device. The sidelink message transmission component 850 is capable of, configured to, or operable to support a means for transmitting an indication of one or more resources of the set of multiple resources for the ambient wireless device to use to backscatter a sidelink data message. The waveform transmission component 855 is capable of, configured to, or operable to support a means for transmitting, via a first resource of the one or more resources, a continuous waveform for sidelink communications at the ambient wireless device. The waveform reception component 835 is capable of, configured to, or operable to support a means for receiving, via a second resource of the one or more resources, a backscattered signal of the continuous waveform modulated with the sidelink data message.

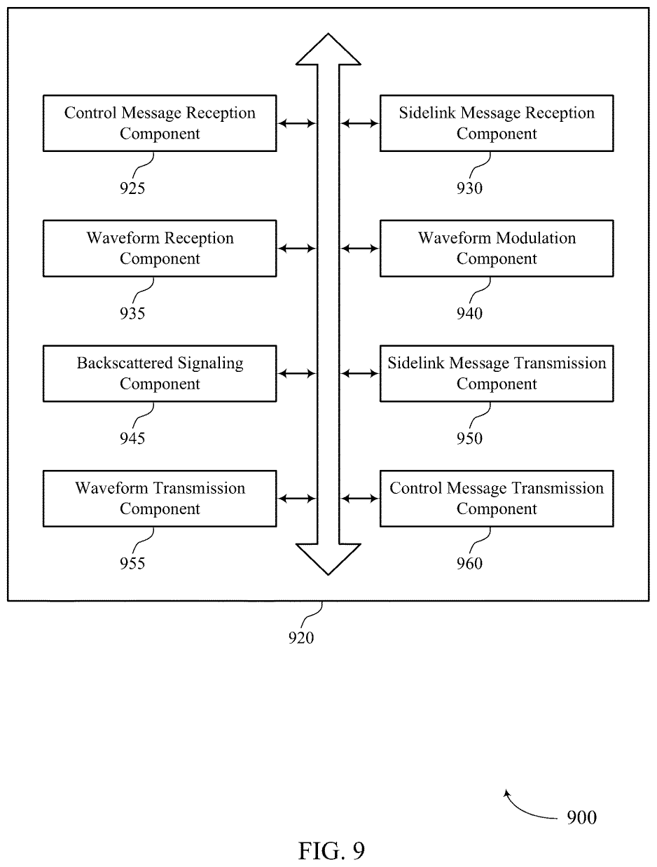

FIG. 9 shows a block diagram 900 of a communications manager 920 that supports resource allocation and communication techniques for ambient wireless devices in accordance with one or more aspects of the present disclosure. The communications manager 920 may be an example of aspects of a communications manager 720, a communications manager 820, or both, as described herein. The communications manager 920, or various components thereof, may be an example of means for performing various aspects of resource allocation and communication techniques for ambient wireless devices as described herein. For example, the communications manager 920 may include a control message reception component 925, a sidelink message reception component 930, a waveform reception component 935, a waveform modulation component 940, a backscattered signaling component 945, a sidelink message transmission component 950, a waveform transmission component 955, a control message transmission component 960, or any combination thereof. Each of these components may communicate, directly or indirectly, with one another (e.g., via one or more buses).

The communications manager 920 may support wireless communications in accordance with examples as disclosed herein. The control message reception component 925 is capable of, configured to, or operable to support a means for receiving a control message that indicates a resource pool allocation for the ambient wireless device, the resource pool allocation including a set of multiple resources for backscatter communications between the ambient wireless device and a UE. The sidelink message reception component 930 is capable of, configured to, or operable to support a means for receiving, from the UE, a sidelink data message via a first resource of the set of multiple resources based on the resource pool allocation. The waveform reception component 935 is capable of, configured to, or operable to support a means for receiving, via a second resource of the set of multiple resources, a continuous waveform for activation of the ambient wireless device to provide feedback for the sidelink data message. The waveform modulation component 940 is capable of, configured to, or operable to support a means for modulating the continuous waveform with feedback information for the sidelink data message. The backscattered signaling component 945 is capable of, configured to, or operable to support a means for sending, via a third resource of the set of multiple resources, a backscattered signal of the continuous waveform modulated with the feedback information for the sidelink data message.

In some examples, the continuous waveform is received from the UE, and the control message reception component 925 is capable of, configured to, or operable to support a means for receiving, from the UE, a feedback resource message indicating that the third resource is allocated for the ambient wireless device to provide feedback for the sidelink data message, the backscattered signal sent via the third resource based on the feedback resource message.

In some examples, to support sending the backscattered signal, the backscattered signaling component 945 is capable of, configured to, or operable to support a means for sending, via the third resource of the set of multiple resources, the backscattered signal, the third resource selected by the UE.

In some examples, the control message reception component 925 is capable of, configured to, or operable to support a means for receiving an indication of a set of resources for feedback for the sidelink data message based on a mapping of the first resource to the set of resources, the third resource selected from the set of resources.

In some examples, the control message reception component 925 is capable of, configured to, or operable to support a means for receiving, via the control message, an indication of a frequency range for the set of multiple resources for backscatter communications.

In some examples, the control message reception component 925 is capable of, configured to, or operable to support a means for receiving, via the control message, an indication of a guard band between the set of multiple resources for backscatter communications and a second set of multiple resources for sidelink communications.

In some examples, the waveform reception component 935 is capable of, configured to, or operable to support a means for receiving a second continuous waveform for a discovery procedure between the ambient wireless device and the UE. In some examples, the waveform modulation component 940 is capable of, configured to, or operable to support a means for modulating the second continuous waveform with an acknowledgment of the discovery procedure. In some examples, the backscattered signaling component 945 is capable of, configured to, or operable to support a means for sending, as part of the discovery procedure, a second backscattered signal of the second continuous waveform modulated with the acknowledgment of the discovery procedure.

Additionally, or alternatively, the communications manager 920 may support wireless communications in accordance with examples as disclosed herein. In some examples, the control message reception component 925 is capable of, configured to, or operable to support a means for receiving a control message that indicates a resource pool allocation for the UE, the resource pool allocation including a set of multiple resources for backscatter communications between the UE and an ambient wireless device. The sidelink message transmission component 950 is capable of, configured to, or operable to support a means for transmitting, to the ambient wireless device, a sidelink data message via a first resource of the set of multiple resources based on the resource pool allocation. The waveform transmission component 955 is capable of, configured to, or operable to support a means for transmitting, via a second resource of the set of multiple resources, a continuous waveform for activation of the ambient wireless device to provide feedback for the sidelink data message. In some examples, the waveform reception component 935 is capable of, configured to, or operable to support a means for receiving, via a third resource of the set of multiple resources, a backscattered signal of the continuous waveform modulated with feedback information for the sidelink data message.

In some examples, the control message transmission component 960 is capable of, configured to, or operable to support a means for transmitting, to the ambient wireless device, a feedback resource message indicating that the third resource is allocated for feedback for the sidelink data message, the backscattered signal received via the third resource based on the feedback resource message.

In some examples, the control message reception component 925 is capable of, configured to, or operable to support a means for receiving, via the control message, an indication of a frequency range for the set of multiple resources for backscatter communications.

In some examples, the control message reception component 925 is capable of, configured to, or operable to support a means for receiving, via the control message, an indication of a guard band between the set of multiple resources for backscatter communications and a second set of multiple resources for sidelink communications.

In some examples, the waveform reception component 935 is capable of, configured to, or operable to support a means for transmitting, to the ambient wireless device, a second continuous waveform for a discovery procedure between the ambient wireless device and the UE. In some examples, the waveform transmission component 955 is capable of, configured to, or operable to support a means for receiving, from the ambient wireless device as part of the discovery procedure, a second backscattered signal of the second continuous waveform modulated with an acknowledgment of the discovery procedure.

Additionally, or alternatively, the communications manager 920 may support wireless communications in accordance with examples as disclosed herein. In some examples, the control message reception component 925 is capable of, configured to, or operable to support a means for receiving a control message that indicates a resource pool allocation for the second UE, the resource pool allocation including a set of multiple resources for backscatter communications for a first UE, the second UE, and an ambient wireless device. In some examples, the waveform transmission component 955 is capable of, configured to, or operable to support a means for transmitting, via a first resource of the set of multiple resources to the ambient wireless device, a continuous waveform for activation of the ambient wireless device for the ambient wireless device to provide feedback to the first UE.

Additionally, or alternatively, the communications manager 920 may support wireless communications in accordance with examples as disclosed herein. In some examples, the control message reception component 925 is capable of, configured to, or operable to support a means for receiving a control message that indicates a resource pool allocation for the ambient wireless device, the resource pool allocation including a set of multiple resources for backscatter communications between the ambient wireless device and a UE. In some examples, the control message reception component 925 is capable of, configured to, or operable to support a means for receiving an indication of one or more resources of the set of multiple resources for the ambient wireless device to use to backscatter a sidelink data message. In some examples, the waveform reception component 935 is capable of, configured to, or operable to support a means for receiving, via a first resource of the one or more resources, a continuous waveform for sidelink communications from the ambient wireless device. In some examples, the waveform modulation component 940 is capable of, configured to, or operable to support a means for modulating the continuous waveform with the sidelink data message. In some examples, the backscattered signaling component 945 is capable of, configured to, or operable to support a means for sending, via a second resource of the one or more resources, a backscattered signal of the continuous waveform modulated with the sidelink data message.

In some examples, the sidelink message reception component 930 is capable of, configured to, or operable to support a means for receiving, from the UE, a feedback message that includes feedback information associated with the sidelink data message based on the backscattered signal of the continuous waveform modulated with the sidelink data message.

In some examples, the waveform reception component 935 is capable of, configured to, or operable to support a means for receiving a second continuous waveform for activation of the ambient wireless device to perform backscatter communications. In some examples, the waveform modulation component 940 is capable of, configured to, or operable to support a means for modulating the second continuous waveform with a backscatter request message associated with the sidelink data message, the backscatter request message including a request for one or more resources for the ambient wireless device to send the sidelink data message. In some examples, the backscattered signaling component 945 is capable of, configured to, or operable to support a means for sending, via a third resource of the set of multiple resources, a second backscattered signal of the second continuous waveform modulated with the backscatter request message.

In some examples, the waveform reception component 935 is capable of, configured to, or operable to support a means for receiving the second continuous waveform from the UE or a second UE different from the UE.

In some examples, the third resource of the set of multiple resources is allocated for the ambient wireless device to send one or more backscatter request messages. In some examples, the third resource is common to a set of ambient wireless devices or is a resource of a communication link associated with the ambient wireless device.

In some examples, the sidelink message transmission component 950 is capable of, configured to, or operable to support a means for sending an indication that the ambient wireless device selected the second resource of the one or more resources to backscatter the sidelink data message. In some examples, the sidelink message reception component 930 is capable of, configured to, or operable to support a means for receiving an acknowledgment message for the indication of the second resource.

In some examples, to support receiving the indication of the one or more resources, the sidelink message reception component 930 is capable of, configured to, or operable to support a means for receiving the indication of the one or more resources of the set of multiple resources from the UE or a second UE different from the UE.

In some examples, the waveform reception component 935 is capable of, configured to, or operable to support a means for receiving a second continuous waveform for a discovery procedure between the ambient wireless device and the UE. In some examples, the waveform modulation component 940 is capable of, configured to, or operable to support a means for modulating the second continuous waveform with capability information of the ambient wireless device. In some examples, the backscattered signaling component 945 is capable of, configured to, or operable to support a means for sending, as part of the discovery procedure, a second backscattered signal of the second continuous waveform modulated with the capability information of the ambient wireless device.

In some examples, the capability information includes capability of frequency shifting at the ambient wireless device, whether the ambient wireless device includes a band pass filter, or both.

Additionally, or alternatively, the communications manager 920 may support wireless communications in accordance with examples as disclosed herein. In some examples, the control message reception component 925 is capable of, configured to, or operable to support a means for receiving a control message that indicates a resource pool allocation for the UE, the resource pool allocation including a set of multiple resources for backscatter communications between the UE and an ambient wireless device. In some examples, the sidelink message transmission component 950 is capable of, configured to, or operable to support a means for transmitting an indication of one or more resources of the set of multiple resources for the ambient wireless device to use to backscatter a sidelink data message. In some examples, the waveform transmission component 955 is capable of, configured to, or operable to support a means for transmitting, via a first resource of the one or more resources, a continuous waveform for sidelink communications at the ambient wireless device. In some examples, the waveform reception component 935 is capable of, configured to, or operable to support a means for receiving, via a second resource of the one or more resources, a backscattered signal of the continuous waveform modulated with the sidelink data message.

In some examples, the sidelink message transmission component 950 is capable of, configured to, or operable to support a means for transmitting, to the ambient wireless device, a feedback message associated with the sidelink data message based on the received backscattered signal of the continuous waveform modulated with the sidelink data message.

In some examples, the waveform transmission component 955 is capable of, configured to, or operable to support a means for transmitting, to the ambient wireless device, a second continuous waveform for activation of the ambient wireless device to perform backscatter communications. In some examples, the waveform reception component 935 is capable of, configured to, or operable to support a means for receiving, via a third resource of the set of multiple resources, a second backscattered signal of the second continuous waveform modulated with a backscatter request message that requests an indication of one or more resources for the ambient wireless device to send the sidelink data message.

In some examples, the third resource of the set of multiple resources is allocated for the ambient wireless device to send one or more backscatter request messages.

In some examples, to support transmitting the indication of one or more resources of the set of multiple resources, the sidelink message transmission component 950 is capable of, configured to, or operable to support a means for transmitting the indication of one or more resources of the set of multiple resources, the one or more resources selected based on a capability of the ambient wireless device.

In some examples, a frequency of the second resource of the one or more resources is greater than a bandwidth of a bandpass filter associated with the ambient wireless device.

In some examples, the sidelink message reception component 930 is capable of, configured to, or operable to support a means for receiving an indication that the ambient wireless device selected the second resource of the one or more resources to backscatter the sidelink data message. In some examples, the sidelink message transmission component 950 is capable of, configured to, or operable to support a means for transmitting an acknowledgment message that the ambient wireless device selected the second resource of the one or more resources to backscatter the sidelink data message.

In some examples, the waveform transmission component 955 is capable of, configured to, or operable to support a means for transmitting, to the ambient wireless device, a second continuous waveform for a discovery procedure between the ambient wireless device and the UE. In some examples, the waveform reception component 935 is capable of, configured to, or operable to support a means for receiving, from the ambient wireless device as part of the discovery procedure, a second backscattered signal of the second continuous waveform modulated with capability information of the ambient wireless device.

In some examples, the capability information includes capability of frequency shifting at the ambient wireless device, whether the ambient wireless device includes a band pass filter, or both.

In some examples, the sidelink message transmission component 950 is capable of, configured to, or operable to support a means for transmitting, to multiple ambient wireless devices, respective indications of resources for the multiple ambient wireless devices to use to backscatter respective sidelink data messages.

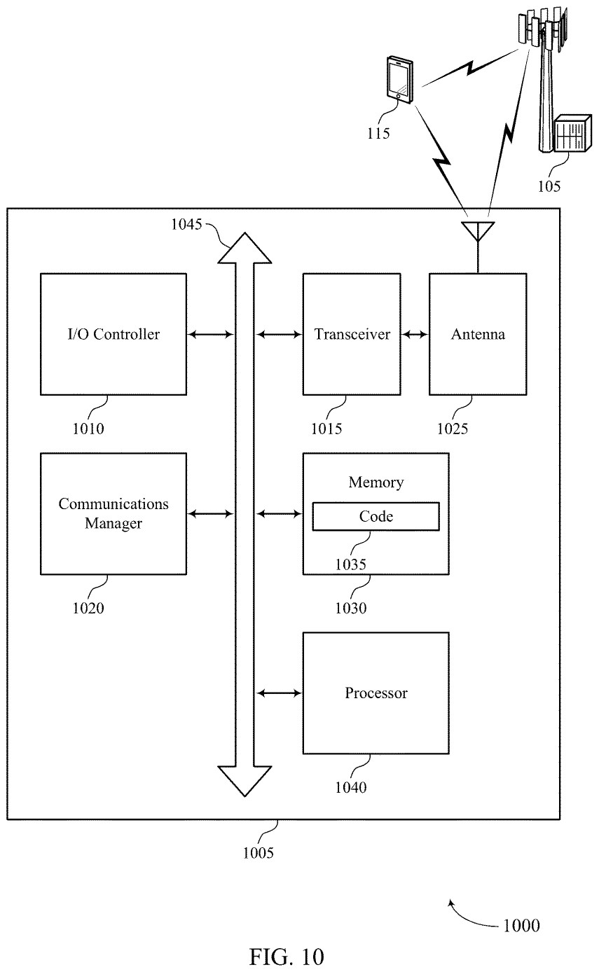

FIG. 10 shows a diagram of a system 1000 including a device 1005 that supports resource allocation and communication techniques for ambient wireless devices in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040.

These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting resource allocation and communication techniques for ambient wireless devices). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications in accordance with examples as disclosed herein. For example, the communications manager 1020 is capable of, configured to, or operable to support a means for receiving a control message that indicates a resource pool allocation for the ambient wireless device, the resource pool allocation including a set of multiple resources for backscatter communications between the ambient wireless device and a UE. The communications manager 1020 is capable of, configured to, or operable to support a means for receiving, from the UE, a sidelink data message via a first resource of the set of multiple resources based on the resource pool allocation. The communications manager 1020 is capable of, configured to, or operable to support a means for receiving, via a second resource of the set of multiple resources, a continuous waveform for activation of the ambient wireless device to provide feedback for the sidelink data message. The communications manager 1020 is capable of, configured to, or operable to support a means for modulating the continuous waveform with feedback information for the sidelink data message. The communications manager 1020 is capable of, configured to, or operable to support a means for sending, via a third resource of the set of multiple resources, a backscattered signal of the continuous waveform modulated with the feedback information for the sidelink data message.

Additionally, or alternatively, the communications manager 1020 may support wireless communications in accordance with examples as disclosed herein. For example, the communications manager 1020 is capable of, configured to, or operable to support a means for receiving a control message that indicates a resource pool allocation for the UE, the resource pool allocation including a set of multiple resources for backscatter communications between the UE and an ambient wireless device. The communications manager 1020 is capable of, configured to, or operable to support a means for transmitting, to the ambient wireless device, a sidelink data message via a first resource of the set of multiple resources based on the resource pool allocation. The communications manager 1020 is capable of, configured to, or operable to support a means for transmitting, via a second resource of the set of multiple resources, a continuous waveform for activation of the ambient wireless device to provide feedback for the sidelink data message. The communications manager 1020 is capable of, configured to, or operable to support a means for receiving, via a third resource of the set of multiple resources, a backscattered signal of the continuous waveform modulated with feedback information for the sidelink data message.

Additionally, or alternatively, the communications manager 1020 may support wireless communications in accordance with examples as disclosed herein. For example, the communications manager 1020 is capable of, configured to, or operable to support a means for receiving a control message that indicates a resource pool allocation for the second UE, the resource pool allocation including a set of multiple resources for backscatter communications for a first UE, the second UE, and an ambient wireless device. The communications manager 1020 is capable of, configured to, or operable to support a means for transmitting, via a first resource of the set of multiple resources to the ambient wireless device, a continuous waveform for activation of the ambient wireless device for the ambient wireless device to provide feedback to the first UE.

Additionally, or alternatively, the communications manager 1020 may support wireless communications in accordance with examples as disclosed herein. For example, the communications manager 1020 is capable of, configured to, or operable to support a means for receiving a control message that indicates a resource pool allocation for the ambient wireless device, the resource pool allocation including a set of multiple resources for backscatter communications between the ambient wireless device and a UE. The communications manager 1020 is capable of, configured to, or operable to support a means for receiving an indication of one or more resources of the set of multiple resources for the ambient wireless device to use to backscatter a sidelink data message. The communications manager 1020 is capable of, configured to, or operable to support a means for receiving, via a first resource of the one or more resources, a continuous waveform for sidelink communications from the ambient wireless device. The communications manager 1020 is capable of, configured to, or operable to support a means for modulating the continuous waveform with the sidelink data message. The communications manager 1020 is capable of, configured to, or operable to support a means for sending, via a second resource of the one or more resources, a backscattered signal of the continuous waveform modulated with the sidelink data message.

Additionally, or alternatively, the communications manager 1020 may support wireless communications in accordance with examples as disclosed herein. For example, the communications manager 1020 is capable of, configured to, or operable to support a means for receiving a control message that indicates a resource pool allocation for the UE, the resource pool allocation including a set of multiple resources for backscatter communications between the UE and an ambient wireless device. The communications manager 1020 is capable of, configured to, or operable to support a means for transmitting an indication of one or more resources of the set of multiple resources for the ambient wireless device to use to backscatter a sidelink data message. The communications manager 1020 is capable of, configured to, or operable to support a means for transmitting, via a first resource of the one or more resources, a continuous waveform for sidelink communications at the ambient wireless device. The communications manager 1020 is capable of, configured to, or operable to support a means for receiving, via a second resource of the one or more resources, a backscattered signal of the continuous waveform modulated with the sidelink data message.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of resource allocation and communication techniques for ambient wireless devices as described herein, or the processor 1040 and the memory 1030 may be otherwise configured to perform or support such operations.

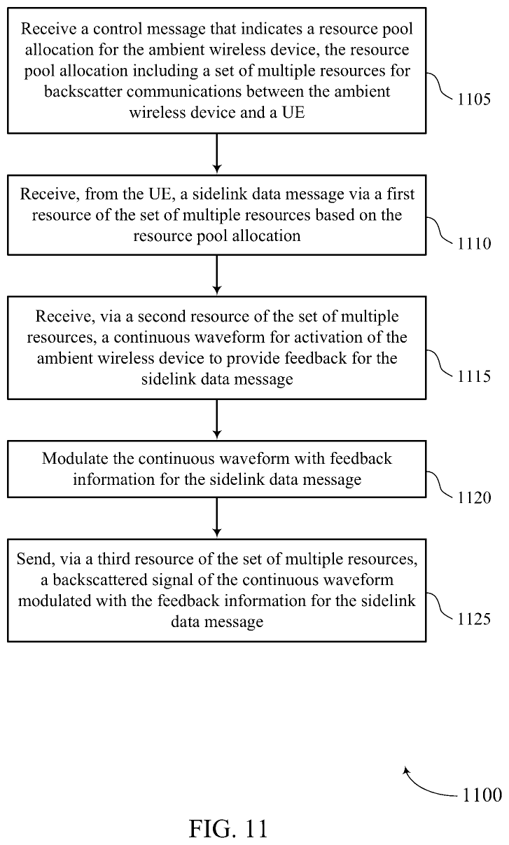

FIG. 11 shows a flowchart illustrating a method 1100 that supports resource allocation and communication techniques for ambient wireless devices in accordance with aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1105, the method may include receiving a control message that indicates a resource pool allocation for the ambient wireless device, the resource pool allocation including a set of multiple resources for backscatter communications between the ambient wireless device and a UE. The operations of 1105 may be performed in accordance with examples as disclosed herein. In some examples, aspects of the operations of 1105 may be performed by a control message reception component 925 as described with reference to FIG. 9.

At 1110, the method may include receiving, from the UE, a sidelink data message via a first resource of the set of multiple resources based on the resource pool allocation. The operations of 1110 may be performed in accordance with examples as disclosed herein. In some examples, aspects of the operations of 1110 may be performed by a sidelink message reception component 930 as described with reference to FIG. 9.

At 1115, the method may include receiving, via a second resource of the set of multiple resources, a continuous waveform for activation of the ambient wireless device to provide feedback for the sidelink data message. The operations of 1115 may be performed in accordance with examples as disclosed herein. In some examples, aspects of the operations of 1115 may be performed by a waveform reception component 935 as described with reference to FIG. 9.

At 1120, the method may include modulating the continuous waveform with feedback information for the sidelink data message. The operations of 1120 may be performed in accordance with examples as disclosed herein. In some examples, aspects of the operations of 1120 may be performed by a waveform modulation component 940 as described with reference to FIG. 9.

At 1125, the method may include sending, via a third resource of the set of multiple resources, a backscattered signal of the continuous waveform modulated with the feedback information for the sidelink data message. The operations of 1125 may be performed in accordance with examples as disclosed herein. In some examples, aspects of the operations of 1125 may be performed by a backscattered signaling component 945 as described with reference to FIG. 9.

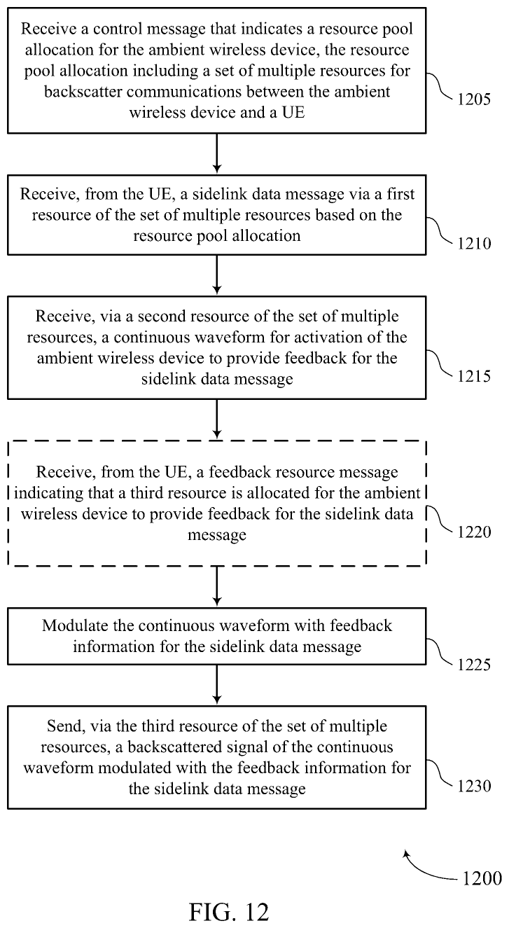

FIG. 12 shows a flowchart illustrating a method 1200 that supports resource allocation and communication techniques for ambient wireless devices in accordance with aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1205, the method may include receiving a control message that indicates a resource pool allocation for the ambient wireless device, the resource pool allocation including a set of multiple resources for backscatter communications between the ambient wireless device and a UE. The operations of 1205 may be performed in accordance with examples as disclosed herein. In some examples, aspects of the operations of 1205 may be performed by a control message reception component 925 as described with reference to FIG. 9.

At 1210, the method may include receiving, from the UE, a sidelink data message via a first resource of the set of multiple resources based on the resource pool allocation. The operations of 1210 may be performed in accordance with examples as disclosed herein. In some examples, aspects of the operations of 1210 may be performed by a sidelink message reception component 930 as described with reference to FIG. 9.

At 1215, the method may include receiving, via a second resource of the set of multiple resources, a continuous waveform for activation of the ambient wireless device to provide feedback for the sidelink data message. The operations of 1215 may be performed in accordance with examples as disclosed herein. In some examples, aspects of the operations of 1215 may be performed by a waveform reception component 935 as described with reference to FIG. 9.

At 1220, the method may include receiving, from the UE, a feedback resource message indicating that the third resource is allocated for the ambient wireless device to provide feedback for the sidelink data message, the backscattered signal sent via the third resource based on the feedback resource message. The operations of 1220 may be performed in accordance with examples as disclosed herein. In some examples, aspects of the operations of 1220 may be performed by a control message reception component 925 as described with reference to FIG. 9.

At 1225, the method may include modulating the continuous waveform with feedback information for the sidelink data message. The operations of 1225 may be performed in accordance with examples as disclosed herein. In some examples, aspects of the operations of 1225 may be performed by a waveform modulation component 940 as described with reference to FIG. 9.

At 1230, the method may include sending, via a third resource of the set of multiple resources, a backscattered signal of the continuous waveform modulated with the feedback information for the sidelink data message. The operations of 1230 may be performed in accordance with examples as disclosed herein. In some examples, aspects of the operations of 1230 may be performed by a backscattered signaling component 945 as described with reference to FIG. 9.

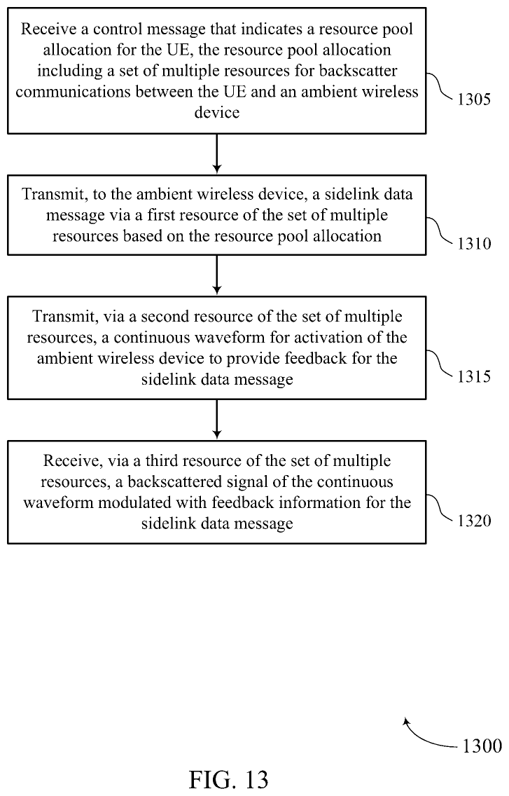

FIG. 13 shows a flowchart illustrating a method 1300 that supports resource allocation and communication techniques for ambient wireless devices in accordance with aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving a control message that indicates a resource pool allocation for the UE, the resource pool allocation including a set of multiple resources for backscatter communications between the UE and an ambient wireless device. The operations of 1305 may be performed in accordance with examples as disclosed herein. In some examples, aspects of the operations of 1305 may be performed by a control message reception component 925 as described with reference to FIG. 9.

At 1310, the method may include transmitting, to the ambient wireless device, a sidelink data message via a first resource of the set of multiple resources based on the resource pool allocation. The operations of 1310 may be performed in accordance with examples as disclosed herein. In some examples, aspects of the operations of 1310 may be performed by a sidelink message transmission component 950 as described with reference to FIG. 9.

At 1315, the method may include transmitting, via a second resource of the set of multiple resources, a continuous waveform for activation of the ambient wireless device to provide feedback for the sidelink data message. The operations of 1315 may be performed in accordance with examples as disclosed herein. In some examples, aspects of the operations of 1315 may be performed by a waveform transmission component 955 as described with reference to FIG. 9.

At 1320, the method may include receiving, via a third resource of the set of multiple resources, a backscattered signal of the continuous waveform modulated with feedback information for the sidelink data message. The operations of 1320 may be performed in accordance with examples as disclosed herein. In some examples, aspects of the operations of 1320 may be performed by a waveform reception component 935 as described with reference to FIG. 9.

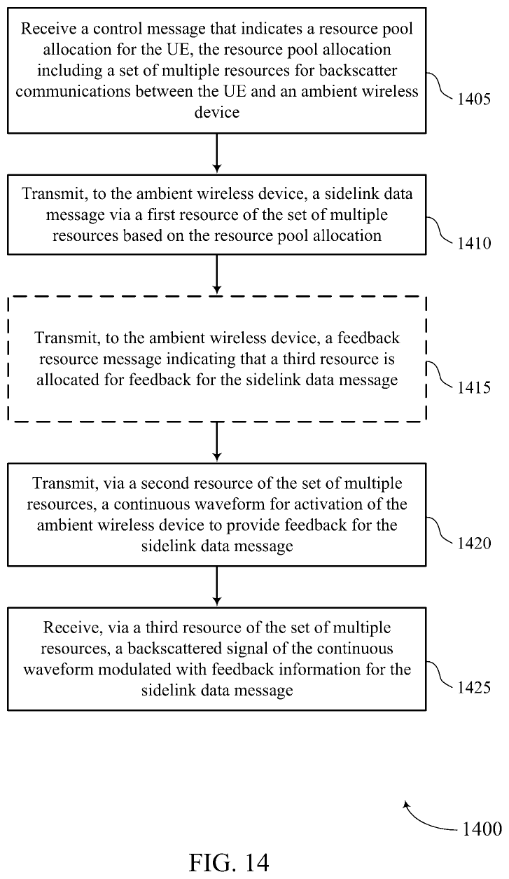

FIG. 14 shows a flowchart illustrating a method 1400 that supports resource allocation and communication techniques for ambient wireless devices in accordance with aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving a control message that indicates a resource pool allocation for the UE, the resource pool allocation including a set of multiple resources for backscatter communications between the UE and an ambient wireless device. The operations of 1405 may be performed in accordance with examples as disclosed herein. In some examples, aspects of the operations of 1405 may be performed by a control message reception component 925 as described with reference to FIG. 9.

At 1410, the method may include transmitting, to the ambient wireless device, a sidelink data message via a first resource of the set of multiple resources based on the resource pool allocation. The operations of 1410 may be performed in accordance with examples as disclosed herein. In some examples, aspects of the operations of 1410 may be performed by a sidelink message transmission component 950 as described with reference to FIG. 9.

At 1415, the method may include transmitting, to the ambient wireless device, a feedback resource message indicating that the third resource is allocated for feedback for the sidelink data message, the backscattered signal received via the third resource based on the feedback resource message. The operations of 1415 may be performed in accordance with examples as disclosed herein. In some examples, aspects of the operations of 1415 may be performed by a control message transmission component 960 as described with reference to FIG. 9.

At 1420, the method may include transmitting, via a second resource of the set of multiple resources, a continuous waveform for activation of the ambient wireless device to provide feedback for the sidelink data message. The operations of 1420 may be performed in accordance with examples as disclosed herein. In some examples, aspects of the operations of 1420 may be performed by a waveform transmission component 955 as described with reference to FIG. 9.

At 1425, the method may include receiving, via a third resource of the set of multiple resources, a backscattered signal of the continuous waveform modulated with feedback information for the sidelink data message. The operations of 1425 may be performed in accordance with examples as disclosed herein. In some examples, aspects of the operations of 1425 may be performed by a waveform reception component 935 as described with reference to FIG. 9.

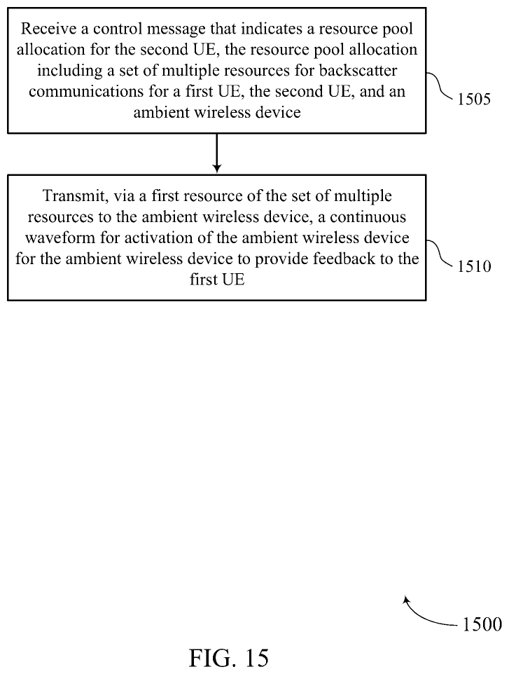

FIG. 15 shows a flowchart illustrating a method 1500 that supports resource allocation and communication techniques for ambient wireless devices in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving a control message that indicates a resource pool allocation for the second UE, the resource pool allocation including a set of multiple resources for backscatter communications for a first UE, the second UE, and an ambient wireless device. The operations of 1505 may be performed in accordance with examples as disclosed herein. In some examples, aspects of the operations of 1505 may be performed by a control message reception component 925 as described with reference to FIG. 9.

At 1510, the method may include transmitting, via a first resource of the set of multiple resources to the ambient wireless device, a continuous waveform for activation of the ambient wireless device for the ambient wireless device to provide feedback to the first UE. The operations of 1510 may be performed in accordance with examples as disclosed herein. In some examples, aspects of the operations of 1510 may be performed by a waveform transmission component 955 as described with reference to FIG. 9.

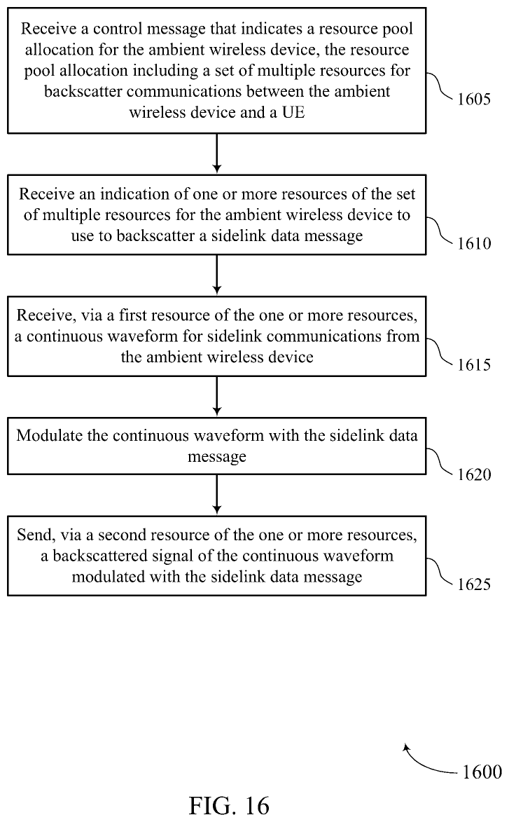

FIG. 16 shows a flowchart illustrating a method 1600 that supports resource allocation and communication techniques for ambient wireless devices in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving a control message that indicates a resource pool allocation for the ambient wireless device, the resource pool allocation including a set of multiple resources for backscatter communications between the ambient wireless device and a UE. The operations of 1605 may be performed in accordance with examples as disclosed herein. In some examples, aspects of the operations of 1605 may be performed by a control message reception component 925 as described with reference to FIG. 9.

At 1610, the method may include receiving an indication of one or more resources of the set of multiple resources for the ambient wireless device to use to backscatter a sidelink data message. The operations of 1610 may be performed in accordance with examples as disclosed herein. In some examples, aspects of the operations of 1610 may be performed by a control message reception component 925 as described with reference to FIG. 9.

At 1615, the method may include receiving, via a first resource of the one or more resources, a continuous waveform for sidelink communications from the ambient wireless device. The operations of 1615 may be performed in accordance with examples as disclosed herein. In some examples, aspects of the operations of 1615 may be performed by a waveform reception component 935 as described with reference to FIG. 9.

At 1620, the method may include modulating the continuous waveform with the sidelink data message. The operations of 1620 may be performed in accordance with examples as disclosed herein. In some examples, aspects of the operations of 1620 may be performed by a waveform modulation component 940 as described with reference to FIG. 9.

At 1625, the method may include sending, via a second resource of the one or more resources, a backscattered signal of the continuous waveform modulated with the sidelink data message. The operations of 1625 may be performed in accordance with examples as disclosed herein. In some examples, aspects of the operations of 1625 may be performed by a backscattered signaling component 945 as described with reference to FIG. 9.

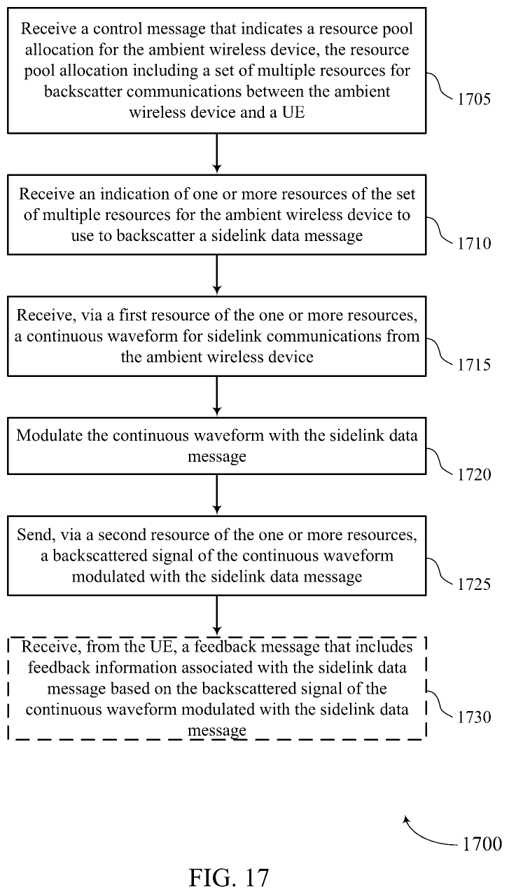

FIG. 17 shows a flowchart illustrating a method 1700 that supports resource allocation and communication techniques for ambient wireless devices in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1705, the method may include receiving a control message that indicates a resource pool allocation for the ambient wireless device, the resource pool allocation including a set of multiple resources for backscatter communications between the ambient wireless device and a UE. The operations of 1705 may be performed in accordance with examples as disclosed herein. In some examples, aspects of the operations of 1705 may be performed by a control message reception component 925 as described with reference to FIG. 9.

At 1710, the method may include receiving an indication of one or more resources of the set of multiple resources for the ambient wireless device to use to backscatter a sidelink data message. The operations of 1710 may be performed in accordance with examples as disclosed herein. In some examples, aspects of the operations of 1710 may be performed by a control message reception component 925 as described with reference to FIG. 9.

At 1715, the method may include receiving, via a first resource of the one or more resources, a continuous waveform for sidelink communications from the ambient wireless device. The operations of 1715 may be performed in accordance with examples as disclosed herein. In some examples, aspects of the operations of 1715 may be performed by a waveform reception component 935 as described with reference to FIG. 9.

At 1720, the method may include modulating the continuous waveform with the sidelink data message. The operations of 1720 may be performed in accordance with examples as disclosed herein. In some examples, aspects of the operations of 1720 may be performed by a waveform modulation component 940 as described with reference to FIG. 9.

At 1725, the method may include sending, via a second resource of the one or more resources, a backscattered signal of the continuous waveform modulated with the sidelink data message. The operations of 1725 may be performed in accordance with examples as disclosed herein. In some examples, aspects of the operations of 1725 may be performed by a backscattered signaling component 945 as described with reference to FIG. 9.

At 1730, the method may include receiving, from the UE, a feedback message that includes feedback information associated with the sidelink data message based on the backscattered signal of the continuous waveform modulated with the sidelink data message. The operations of 1730 may be performed in accordance with examples as disclosed herein. In some examples, aspects of the operations of 1730 may be performed by a sidelink message reception component 930 as described with reference to FIG. 9.

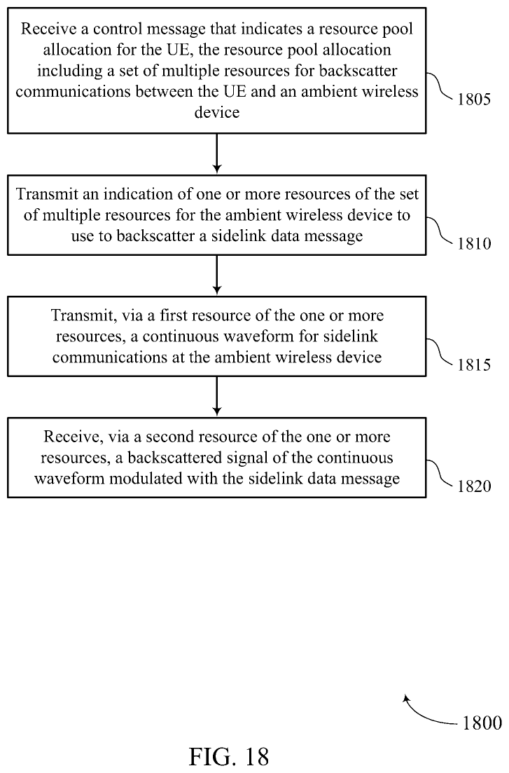

FIG. 18 shows a flowchart illustrating a method 1800 that supports resource allocation and communication techniques for ambient wireless devices in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1805, the method may include receiving a control message that indicates a resource pool allocation for the UE, the resource pool allocation including a set of multiple resources for backscatter communications between the UE and an ambient wireless device. The operations of 1805 may be performed in accordance with examples as disclosed herein. In some examples, aspects of the operations of 1805 may be performed by a control message reception component 925 as described with reference to FIG. 9.

At 1810, the method may include transmitting an indication of one or more resources of the set of multiple resources for the ambient wireless device to use to backscatter a sidelink data message. The operations of 1810 may be performed in accordance with examples as disclosed herein. In some examples, aspects of the operations of 1810 may be performed by a sidelink message transmission component 950 as described with reference to FIG. 9.

At 1815, the method may include transmitting, via a first resource of the one or more resources, a continuous waveform for sidelink communications at the ambient wireless device. The operations of 1815 may be performed in accordance with examples as disclosed herein. In some examples, aspects of the operations of 1815 may be performed by a waveform transmission component 955 as described with reference to FIG. 9.

At 1820, the method may include receiving, via a second resource of the one or more resources, a backscattered signal of the continuous waveform modulated with the sidelink data message. The operations of 1820 may be performed in accordance with examples as disclosed herein. In some examples, aspects of the operations of 1820 may be performed by a waveform reception component 935 as described with reference to FIG. 9.

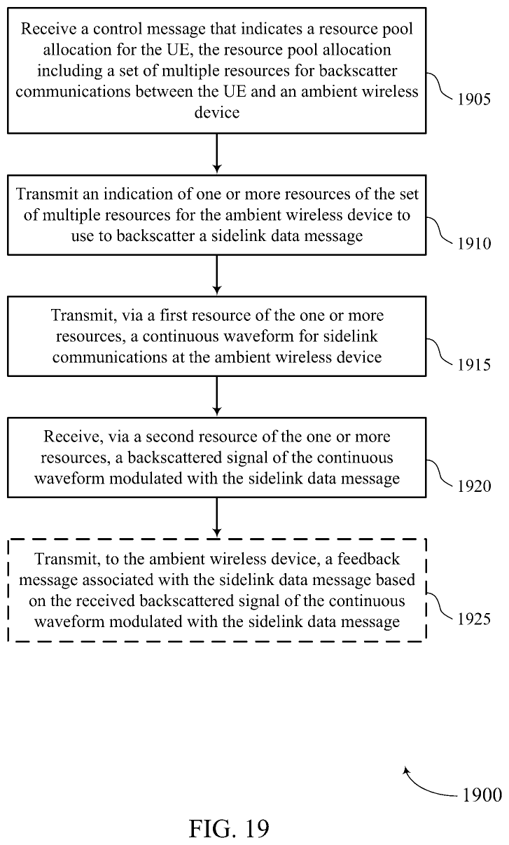

FIG. 19 shows a flowchart illustrating a method 1900 that supports resource allocation and communication techniques for ambient wireless devices in accordance with aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1905, the method may include receiving a control message that indicates a resource pool allocation for the UE, the resource pool allocation including a set of multiple resources for backscatter communications between the UE and an ambient wireless device. The operations of 1905 may be performed in accordance with examples as disclosed herein. In some examples, aspects of the operations of 1905 may be performed by a control message reception component 925 as described with reference to FIG. 9.

At 1910, the method may include transmitting an indication of one or more resources of the set of multiple resources for the ambient wireless device to use to backscatter a sidelink data message. The operations of 1910 may be performed in accordance with examples as disclosed herein. In some examples, aspects of the operations of 1910 may be performed by a sidelink message transmission component 950 as described with reference to FIG. 9.

At 1915, the method may include transmitting, via a first resource of the one or more resources, a continuous waveform for sidelink communications at the ambient wireless device. The operations of 1915 may be performed in accordance with examples as disclosed herein. In some examples, aspects of the operations of 1915 may be performed by a waveform transmission component 955 as described with reference to FIG. 9.

At 1920, the method may include receiving, via a second resource of the one or more resources, a backscattered signal of the continuous waveform modulated with the sidelink data message. The operations of 1920 may be performed in accordance with examples as disclosed herein. In some examples, aspects of the operations of 1920 may be performed by a waveform reception component 935 as described with reference to FIG. 9.

At 1925, the method may include transmitting, to the ambient wireless device, a feedback message associated with the sidelink data message based on the received backscattered signal of the continuous waveform modulated with the sidelink data message. The operations of 1925 may be performed in accordance with examples as disclosed herein. In some examples, aspects of the operations of 1925 may be performed by a sidelink message transmission component 950 as described with reference to FIG. 9.

The following provides an overview of aspects of the present disclosure:

Aspect 1: An apparatus of an ambient wireless device for wireless communications, comprising: a processor; and memory coupled with the processor, the processor configured to: receive a control message that indicates a resource pool allocation for the ambient wireless device, the resource pool allocation comprising a plurality of resources for backscatter communications between the ambient wireless device and a UE; receive, from the UE, a sidelink data message via a first resource of the plurality of resources based at least in part on the resource pool allocation; receive, via a second resource of the plurality of resources, a continuous waveform for activation of the ambient wireless device to provide feedback for the sidelink data message; modulate the continuous waveform with feedback information for the sidelink data message; and send, via a third resource of the plurality of resources, a backscattered signal of the continuous waveform modulated with the feedback information for the sidelink data message.

Aspect 2: The apparatus of aspect 33, wherein the continuous waveform is received from the UE, the processor is further configured to: receive, from the UE, a feedback resource message indicating that the third resource is allocated for the ambient wireless device to provide feedback for the sidelink data message, the backscattered signal sent via the third resource based at least in part on the feedback resource message.

Aspect 3: The apparatus of any of aspects 33 through 34, wherein the continuous waveform is received from a second UE different than the UE, wherein, to send the backscattered signal, the processor is configured to: send, via the third resource of the plurality of resources, the backscattered signal, the third resource selected by the UE.

Aspect 4: The apparatus of aspect 35, wherein the processor is further configured to: receive an indication of a set of resources for feedback for the sidelink data message based at least in part on a mapping of the first resource to the set of resources, the third resource selected from the set of resources.

Aspect 5: The apparatus of any of aspects 33 through 36, wherein the processor is further configured to: receive, via the control message, an indication of a frequency range for the plurality of resources for backscatter communications.

Aspect 6: The apparatus of any of aspects 33 through 37, wherein the processor is further configured to: receive, via the control message, an indication of a guard band between the plurality of resources for backscatter communications and a second plurality of resources for sidelink communications.

Aspect 7: The apparatus of any of aspects 33 through 38, wherein the processor is further configured to: receive a second continuous waveform for a discovery procedure between the ambient wireless device and the UE; modulating the second continuous waveform with an acknowledgment of the discovery procedure; and sending, as part of the discovery procedure, a second backscattered signal of the second continuous waveform modulated with the acknowledgment of the discovery procedure.

Aspect 8: An apparatus of a UE, comprising: a processor; and memory coupled with the processor, the processor configured to: receive a control message that indicates a resource pool allocation for the UE, the resource pool allocation comprising a plurality of resources for backscatter communications between the UE and an ambient wireless device; transmit, to the ambient wireless device, a sidelink data message via a first resource of the plurality of resources based at least in part on the resource pool allocation; transmit, via a second resource of the plurality of resources, a continuous waveform for activation of the ambient wireless device to provide feedback for the sidelink data message; and receive, via a third resource of the plurality of resources, a backscattered signal of the continuous waveform modulated with feedback information for the sidelink data message.

Aspect 9: The apparatus of aspect 40, wherein the processor is further configured to: transmit, to the ambient wireless device, a feedback resource message indicating that the third resource is allocated for feedback for the sidelink data message, the backscattered signal received via the third resource based at least in part on the feedback resource message.

Aspect 10: The apparatus of any of aspects 40 through 41, wherein the processor is further configured to: receive, via the control message, an indication of a frequency range for the plurality of resources for backscatter communications.

Aspect 11: The apparatus of any of aspects 40 through 42, wherein the processor is further configured to: receive, via the control message, an indication of a guard band between the plurality of resources for backscatter communications and a second plurality of resources for sidelink communications.

Aspect 12: The apparatus of any of aspects 40 through 43, wherein the processor is further configured to: transmit, to the ambient wireless device, a second continuous waveform for a discovery procedure between the ambient wireless device and the UE; and receive, from the ambient wireless device as part of the discovery procedure, a second backscattered signal of the second continuous waveform modulated with an acknowledgment of the discovery procedure.

Aspect 13: An apparatus of an ambient wireless device for wireless communications, comprising: a processor; and memory coupled with the processor, the processor configured to: receive a control message that indicates a resource pool allocation for the second UE, the resource pool allocation comprising a plurality of resources for backscatter communications for a first UE, the second UE, and an ambient wireless device; and transmit, via a first resource of the plurality of resources to the ambient wireless device, a continuous waveform for activation of the ambient wireless device for the ambient wireless device to provide feedback to the first UE.

Aspect 14: An apparatus of an ambient wireless device for wireless communications, comprising: a processor; and memory coupled with the processor, the processor configured to: receive a control message that indicates a resource pool allocation for the ambient wireless device, the resource pool allocation comprising a plurality of resources for backscatter communications between the ambient wireless device and a UE; receive an indication of one or more resources of the plurality of resources for the ambient wireless device to use to backscatter a sidelink data message; receive, via a first resource of the one or more resources, a continuous waveform for sidelink communications from the ambient wireless device; modulate the continuous waveform with the sidelink data message; and send, via a second resource of the one or more resources, a backscattered signal of the continuous waveform modulated with the sidelink data message.

Aspect 15: The apparatus of aspect 46, wherein the processor is further configured to: receive, from the UE, a feedback message that comprises feedback information associated with the sidelink data message based at least in part on the backscattered signal of the continuous waveform modulated with the sidelink data message.

Aspect 16: The apparatus of any of aspects 46 through 47, wherein the processor is further configured to: receive a second continuous waveform for activation of the ambient wireless device to perform backscatter communications; modulate the second continuous waveform with a backscatter request message associated with the sidelink data message, the backscatter request message comprising a request for one or more resources for the ambient wireless device to send the sidelink data message; and send, via a third resource of the plurality of resources, a second backscattered signal of the second continuous waveform modulated with the backscatter request message.

Aspect 17: The apparatus of aspect 48, wherein the processor is further configured to: receive the second continuous waveform from the UE or a second UE different from the UE.

Aspect 18: The apparatus of any of aspects 48 through 49, wherein the third resource of the plurality of resources is allocated for the ambient wireless device to send one or more backscatter request messages, the third resource is common to a set of ambient wireless devices or is a resource of a communication link associated with the ambient wireless device.

Aspect 19: The apparatus of any of aspects 46 through 50, wherein the processor is further configured to: send an indication that the ambient wireless device selected the second resource of the one or more resources to backscatter the sidelink data message; and receive an acknowledgment message for the indication of the second resource.

Aspect 20: The apparatus of any of aspects 46 through 51, wherein, to receive the indication of the one or more resources, the processor is further configured to: receive the indication of the one or more resources of the plurality of resources from the UE or a second UE different from the UE.

Aspect 21: The apparatus of any of aspects 46 through 52, wherein the processor is further configured to: receive a second continuous waveform for a discovery procedure between the ambient wireless device and the UE; modulate the second continuous waveform with capability information of the ambient wireless device; and send, as part of the discovery procedure, a second backscattered signal of the second continuous waveform modulated with the capability information of the ambient wireless device.

Aspect 22: The apparatus of aspect 53, wherein the capability information comprises capability of frequency shifting at the ambient wireless device, whether the ambient wireless device comprises a band pass filter, or both.

Aspect 23: An apparatus at a UE comprising: a processor; and memory coupled with the processor, the processor configured to: receive a control message that indicates a resource pool allocation for the UE, the resource pool allocation comprising a plurality of resources for backscatter communications between the UE and an ambient wireless device; transmit an indication of one or more resources of the plurality of resources for the ambient wireless device to use to backscatter a sidelink data message; transmit, via a first resource of the one or more resources, a continuous waveform for sidelink communications at the ambient wireless device; and receive, via a second resource of the one or more resources, a backscattered signal of the continuous waveform modulated with the sidelink data message.

Aspect 24: The apparatus of aspect 55, wherein the processor is further configured to: transmit, to the ambient wireless device, a feedback message associated with the sidelink data message based at least in part on the received backscattered signal of the continuous waveform modulated with the sidelink data message.

Aspect 25: The apparatus of any of aspects 55 through 56, wherein the processor is further configured to: transmit, to the ambient wireless device, a second continuous waveform for activation of the ambient wireless device to perform backscatter communications; and receive, via a third resource of the plurality of resources, a second backscattered signal of the second continuous waveform modulated with a backscatter request message that requests an indication of one or more resources for the ambient wireless device to send the sidelink data message.

Aspect 26: The apparatus of aspect 57, wherein the third resource of the plurality of resources is allocated for the ambient wireless device to send one or more backscatter request messages.

Aspect 27: The apparatus of any of aspects 55 through 58, wherein, to transmit the indication of one or more resources of the plurality of resources, the processor is further configured to: transmit the indication of one or more resources of the plurality of resources, the one or more resources selected based at least in part on a capability of the ambient wireless device.

Aspect 28: The apparatus of aspect 59, wherein a frequency of the second resource of the one or more resources is greater than a bandwidth of a bandpass filter associated with the ambient wireless device.

Aspect 29: The apparatus of any of aspects 55 through 60, wherein the processor is further configured to: receive an indication that the ambient wireless device selected the second resource of the one or more resources to backscatter the sidelink data message; and transmit an acknowledgment message that the ambient wireless device selected the second resource of the one or more resources to backscatter the sidelink data message.

Aspect 30: The apparatus of any of aspects 55 through 61, wherein the processor is further configured to: transmit, to the ambient wireless device, a second continuous waveform for a discovery procedure between the ambient wireless device and the UE; and receive, from the ambient wireless device as part of the discovery procedure, a second backscattered signal of the second continuous waveform modulated with capability information of the ambient wireless device.

Aspect 31: The apparatus of aspect 62, wherein the capability information comprises capability of frequency shifting at the ambient wireless device, whether the ambient wireless device comprises a band pass filter, or both.

Aspect 32: The apparatus of any of aspects 55 through 63, wherein the processor is further configured to: transmit, to multiple ambient wireless devices, respective indications of resources for the multiple ambient wireless devices to use to backscatter respective sidelink data messages.

Aspect 33: A method for wireless communications, at an ambient wireless device, comprising: receiving a control message that indicates a resource pool allocation for the ambient wireless device, the resource pool allocation comprising a plurality of resources for backscatter communications between the ambient wireless device and a UE; receiving, from the UE, a sidelink data message via a first resource of the plurality of resources based at least in part on the resource pool allocation; receiving, via a second resource of the plurality of resources, a continuous waveform for activation of the ambient wireless device to provide feedback for the sidelink data message; modulating the continuous waveform with feedback information for the sidelink data message; and sending, via a third resource of the plurality of resources, a backscattered signal of the continuous waveform modulated with the feedback information for the sidelink data message.

Aspect 34: The method of aspect 33, wherein the continuous waveform is received from the UE, the method further comprising: receiving, from the UE, a feedback resource message indicating that the third resource is allocated for the ambient wireless device to provide feedback for the sidelink data message, the backscattered signal sent via the third resource based at least in part on the feedback resource message.

Aspect 35: The method of any of aspects 33 through 34, wherein the continuous waveform is received from a second UE different than the UE, wherein sending the backscattered signal further comprises: sending, via the third resource of the plurality of resources, the backscattered signal, the third resource selected by the UE.

Aspect 36: The method of aspect 35, further comprising: receiving an indication of a set of resources for feedback for the sidelink data message based at least in part on a mapping of the first resource to the set of resources, the third resource selected from the set of resources.

Aspect 37: The method of any of aspects 33 through 36, further comprising: receiving, via the control message, an indication of a frequency range for the plurality of resources for backscatter communications.

Aspect 38: The method of any of aspects 33 through 37, further comprising: receiving, via the control message, an indication of a guard band between the plurality of resources for backscatter communications and a second plurality of resources for sidelink communications.

Aspect 39: The method of any of aspects 33 through 38, further comprising: receiving a second continuous waveform for a discovery procedure between the ambient wireless device and the UE; modulating the second continuous waveform with an acknowledgment of the discovery procedure; and sending, as part of the discovery procedure, a second backscattered signal of the second continuous waveform modulated with the acknowledgment of the discovery procedure.

Aspect 40: A method for wireless communications, at a UE, comprising: receiving a control message that indicates a resource pool allocation for the UE, the resource pool allocation comprising a plurality of resources for backscatter communications between the UE and an ambient wireless device; transmitting, to the ambient wireless device, a sidelink data message via a first resource of the plurality of resources based at least in part on the resource pool allocation; transmitting, via a second resource of the plurality of resources, a continuous waveform for activation of the ambient wireless device to provide feedback for the sidelink data message; and receiving, via a third resource of the plurality of resources, a backscattered signal of the continuous waveform modulated with feedback information for the sidelink data message.

Aspect 41: The method of aspect 40, further comprising: transmitting, to the ambient wireless device, a feedback resource message indicating that the third resource is allocated for feedback for the sidelink data message, the backscattered signal received via the third resource based at least in part on the feedback resource message.

Aspect 42: The method of any of aspects 40 through 41, further comprising: receiving, via the control message, an indication of a frequency range for the plurality of resources for backscatter communications.

Aspect 43: The method of any of aspects 40 through 42, further comprising: receiving, via the control message, an indication of a guard band between the plurality of resources for backscatter communications and a second plurality of resources for sidelink communications.

Aspect 44: The method of any of aspects 40 through 43, further comprising: transmitting, to the ambient wireless device, a second continuous waveform for a discovery procedure between the ambient wireless device and the UE; and receiving, from the ambient wireless device as part of the discovery procedure, a second backscattered signal of the second continuous waveform modulated with an acknowledgment of the discovery procedure.

Aspect 45: A method for wireless communications, at a second UE, comprising: receiving a control message that indicates a resource pool allocation for the second UE, the resource pool allocation comprising a plurality of resources for backscatter communications for a first UE, the second UE, and an ambient wireless device; and transmitting, via a first resource of the plurality of resources to the ambient wireless device, a continuous waveform for activation of the ambient wireless device for the ambient wireless device to provide feedback to the first UE.

Aspect 46: A method for wireless communications, at an ambient wireless device, comprising: receiving a control message that indicates a resource pool allocation for the ambient wireless device, the resource pool allocation comprising a plurality of resources for backscatter communications between the ambient wireless device and a UE; receiving an indication of one or more resources of the plurality of resources for the ambient wireless device to use to backscatter a sidelink data message; receiving, via a first resource of the one or more resources, a continuous waveform for sidelink communications from the ambient wireless device; modulating the continuous waveform with the sidelink data message; and sending, via a second resource of the one or more resources, a backscattered signal of the continuous waveform modulated with the sidelink data message.

Aspect 47: The method of aspect 46, further comprising: receiving, from the UE, a feedback message that comprises feedback information associated with the sidelink data message based at least in part on the backscattered signal of the continuous waveform modulated with the sidelink data message.

Aspect 48: The method of any of aspects 46 through 47, further comprising: receiving a second continuous waveform for activation of the ambient wireless device to perform backscatter communications; modulating the second continuous waveform with a backscatter request message associated with the sidelink data message, the backscatter request message comprising a request for one or more resources for the ambient wireless device to send the sidelink data message; and sending, via a third resource of the plurality of resources, a second backscattered signal of the second continuous waveform modulated with the backscatter request message.

Aspect 49: The method of aspect 48, further comprising: receiving the second continuous waveform from the UE or a second UE different from the UE.

Aspect 50: The method of any of aspects 48 through 49, wherein the third resource of the plurality of resources is allocated for the ambient wireless device to send one or more backscatter request messages, the third resource is common to a set of ambient wireless devices or is a resource of a communication link associated with the ambient wireless device.

Aspect 51: The method of any of aspects 46 through 50, further comprising: sending an indication that the ambient wireless device selected the second resource of the one or more resources to backscatter the sidelink data message; and receiving an acknowledgment message for the indication of the second resource.

Aspect 52: The method of any of aspects 46 through 51, wherein receiving the indication of the one or more resources comprises: receiving the indication of the one or more resources of the plurality of resources from the UE or a second UE different from the UE.

Aspect 53: The method of any of aspects 46 through 52, further comprising: receiving a second continuous waveform for a discovery procedure between the ambient wireless device and the UE; modulating the second continuous waveform with capability information of the ambient wireless device; and sending, as part of the discovery procedure, a second backscattered signal of the second continuous waveform modulated with the capability information of the ambient wireless device.

Aspect 54: The method of aspect 53, wherein the capability information comprises capability of frequency shifting at the ambient wireless device, whether the ambient wireless device comprises a band pass filter, or both.

Aspect 55: A method for wireless communications, at a UE, comprising: receiving a control message that indicates a resource pool allocation for the UE, the resource pool allocation comprising a plurality of resources for backscatter communications between the UE and an ambient wireless device; transmitting an indication of one or more resources of the plurality of resources for the ambient wireless device to use to backscatter a sidelink data message; transmitting, via a first resource of the one or more resources, a continuous waveform for sidelink communications at the ambient wireless device; and receiving, via a second resource of the one or more resources, a backscattered signal of the continuous waveform modulated with the sidelink data message.

Aspect 56: The method of aspect 55, further comprising: transmitting, to the ambient wireless device, a feedback message associated with the sidelink data message based at least in part on the received backscattered signal of the continuous waveform modulated with the sidelink data message.

Aspect 57: The method of any of aspects 55 through 56, further comprising: transmitting, to the ambient wireless device, a second continuous waveform for activation of the ambient wireless device to perform backscatter communications; and receiving, via a third resource of the plurality of resources, a second backscattered signal of the second continuous waveform modulated with a backscatter request message that requests an indication of one or more resources for the ambient wireless device to send the sidelink data message.

Aspect 58: The method of aspect 57, wherein the third resource of the plurality of resources is allocated for the ambient wireless device to send one or more backscatter request messages.

Aspect 59: The method of any of aspects 55 through 58, wherein transmitting the indication of one or more resources of the plurality of resources further comprises: transmitting the indication of one or more resources of the plurality of resources, the one or more resources selected based at least in part on a capability of the ambient wireless device.

Aspect 60: The method of aspect 59, wherein a frequency of the second resource of the one or more resources is greater than a bandwidth of a bandpass filter associated with the ambient wireless device.

Aspect 61: The method of any of aspects 55 through 60, further comprising: receiving an indication that the ambient wireless device selected the second resource of the one or more resources to backscatter the sidelink data message; and transmitting an acknowledgment message that the ambient wireless device selected the second resource of the one or more resources to backscatter the sidelink data message.

Aspect 62: The method of any of aspects 55 through 61, further comprising: transmitting, to the ambient wireless device, a second continuous waveform for a discovery procedure between the ambient wireless device and the UE; and receiving, from the ambient wireless device as part of the discovery procedure, a second backscattered signal of the second continuous waveform modulated with capability information of the ambient wireless device.

Aspect 63: The method of aspect 62, wherein the capability information comprises capability of frequency shifting at the ambient wireless device, whether the ambient wireless device comprises a band pass filter, or both.

Aspect 64: The method of any of aspects 55 through 63, further comprising: transmitting, to multiple ambient wireless devices, respective indications of resources for the multiple ambient wireless devices to use to backscatter respective sidelink data messages.

Aspect 65: An apparatus for wireless communications, comprising at least one means for performing a method of any of aspects 33 through 39.

Aspect 66: A non-transitory computer-readable medium storing code for wireless communications, the code comprising instructions executable by a processor to perform a method of any of aspects 33 through 39.

Aspect 67: An apparatus for wireless communications, comprising at least one means for performing a method of any of aspects 40 through 44.

Aspect 68: A non-transitory computer-readable medium storing code for wireless communications, the code comprising instructions executable by a processor to perform a method of any of aspects 40 through 44.

Aspect 69: An apparatus for wireless communications, comprising at least one means for performing a method of any of aspects 45 through 45.

Aspect 70: A non-transitory computer-readable medium storing code for wireless communications, the code comprising instructions executable by a processor to perform a method of any of aspects 45 through 45.

Aspect 71: An apparatus for wireless communications, comprising at least one means for performing a method of any of aspects 46 through 54.

Aspect 72: A non-transitory computer-readable medium storing code for wireless communications, the code comprising instructions executable by a processor to perform a method of any of aspects 46 through 54.

Aspect 73: An apparatus for wireless communications, comprising at least one means for performing a method of any of aspects 55 through 64.

Aspect 74: A non-transitory computer-readable medium storing code for wireless communications, the code comprising instructions executable by a processor to perform a method of any of aspects 55 through 64.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus of an ambient wireless device for wireless communications, comprising:
a processor; and
memory coupled with the processor, the processor configured to:
receive a control message that indicates a resource pool allocation for the ambient wireless device, the resource pool allocation comprising a plurality of resources for backscatter communications between the ambient wireless device and a user equipment (UE);
receive, from the UE, a sidelink data message via a first resource of the plurality of resources based at least in part on the resource pool allocation;
receive, via a second resource of the plurality of resources, a continuous waveform for activation of the ambient wireless device to provide feedback for the sidelink data message;
modulate the continuous waveform with feedback information for the sidelink data message; and
send, via a third resource of the plurality of resources, a backscattered signal of the continuous waveform modulated with the feedback information for the sidelink data message.

2. The apparatus of claim 1, wherein the continuous waveform is received from the UE, the processor is further configured to:
receive, from the UE, a feedback resource message indicating that the third resource is allocated for the ambient wireless device to provide feedback for the sidelink data message, the backscattered signal sent via the third resource based at least in part on the feedback resource message.

3. The apparatus of claim 1, wherein, to send the backscattered signal, the processor is configured to:
send, via the third resource of the plurality of resources, the backscattered signal, the third resource selected by the UE.

4. The apparatus of claim 3, wherein the processor is further configured to:
receive an indication of a set of resources for feedback for the sidelink data message based at least in part on a mapping of the first resource to the set of resources, the third resource selected from the set of resources.

5. The apparatus of claim 1, wherein the processor is further configured to:
receive, via the control message, an indication of a frequency range for the plurality of resources for backscatter communications.

6. The apparatus of claim 1, wherein the processor is further configured to:
receive, via the control message, an indication of a guard band between the plurality of resources for backscatter communications and a second plurality of resources for sidelink communications.

7. The apparatus of claim 1, wherein the processor is further configured to:
receive a second continuous waveform for a discovery procedure between the ambient wireless device and the UE;
modulate the second continuous waveform with an acknowledgment of the discovery procedure; and
send, as part of the discovery procedure, a second backscattered signal of the second continuous waveform modulated with the acknowledgment of the discovery procedure.

8. An apparatus of a user equipment (UE) for wireless communications, comprising:
a processor; and
memory coupled with the processor, the processor configured to:
receive a control message that indicates a resource pool allocation for the UE, the resource pool allocation comprising a plurality of resources for backscatter communications between the UE and an ambient wireless device;
transmit, to the ambient wireless device, a sidelink data message via a first resource of the plurality of resources based at least in part on the resource pool allocation;
transmit, via a second resource of the plurality of resources, a continuous waveform for activation of the ambient wireless device to provide feedback for the sidelink data message; and
receive, via a third resource of the plurality of resources, a backscattered signal of the continuous waveform modulated with feedback information for the sidelink data message.

9. The apparatus of claim 8, wherein the processor is further configured to:
transmit, to the ambient wireless device, a feedback resource message indicating that the third resource is allocated for feedback for the sidelink data message, the backscattered signal received via the third resource based at least in part on the feedback resource message.

10. The apparatus of claim 8, wherein the processor is further configured to:
receive, via the control message, an indication of a frequency range for the plurality of resources for backscatter communications.

11. The apparatus of claim 8, wherein the processor is further configured to:
receive, via the control message, an indication of a guard band between the plurality of resources for backscatter communications and a second plurality of resources for sidelink communications.

12. The apparatus of claim 8, wherein the processor is further configured to:
transmit, to the ambient wireless device, a second continuous waveform for a discovery procedure between the ambient wireless device and the UE; and
receive, from the ambient wireless device as part of the discovery procedure, a second backscattered signal of the second continuous waveform modulated with an acknowledgment of the discovery procedure.

13. An apparatus of an ambient wireless device for wireless communications, comprising:
a processor; and
memory coupled with the processor, the processor configured to:
receive a control message that indicates a resource pool allocation for the ambient wireless device, the resource pool allocation comprising a plurality of resources for backscatter communications between the ambient wireless device and a user equipment (UE);
receive an indication of one or more resources of the plurality of resources for the ambient wireless device to use to backscatter a sidelink data message;
receive, via a first resource of the one or more resources, a continuous waveform for sidelink communications from the ambient wireless device;
modulate the continuous waveform with the sidelink data message; and
send, via a second resource of the one or more resources, a backscattered signal of the continuous waveform modulated with the sidelink data message.

14. The apparatus of claim 13, wherein the processor is further configured to:
receive, from the UE, a feedback message that comprises feedback information associated with the sidelink data message based at least in part on the backscattered signal of the continuous waveform modulated with the sidelink data message.

15. The apparatus of claim 13, wherein the processor is further configured to:
receive a second continuous waveform for activation of the ambient wireless device to perform backscatter communications;
modulate the second continuous waveform with a backscatter request message associated with the sidelink data message, the backscatter request message comprising a request for one or more resources for the ambient wireless device to send the sidelink data message; and
send, via a third resource of the plurality of resources, a second backscattered signal of the second continuous waveform modulated with the backscatter request message.

16. The apparatus of claim 15, wherein the processor is further configured to:
receive the second continuous waveform from the UE or a second UE different from the UE.

17. The apparatus of claim 15, wherein the third resource of the plurality of resources is allocated for the ambient wireless device to send one or more backscatter request messages, the third resource is common to a set of ambient wireless devices or is a resource of a communication link associated with the ambient wireless device.

18. The apparatus of claim 13, wherein the processor is further configured to:
send an indication that the ambient wireless device selected the second resource of the one or more resources to backscatter the sidelink data message; and
receive an acknowledgment message for the indication of the second resource.

19. The apparatus of claim 13, wherein, to receive the indication of the one or more resources, the processor is configured to:
receive the indication of the one or more resources of the plurality of resources from the UE or a second UE different from the UE.

20. The apparatus of claim 13, wherein the processor is further configured to:
receive a second continuous waveform for a discovery procedure between the ambient wireless device and the UE;
modulate the second continuous waveform with capability information of the ambient wireless device; and
send, as part of the discovery procedure, a second backscattered signal of the second continuous waveform modulated with the capability information of the ambient wireless device.

21-30. (canceled)
